(19) United States
(12) Patent Application Publication
(10) Pub. No.: US 2026/0327070 A1
(43) Pub. Date: Oct. 22, 2026

(54) CATALYTIC DECOMPOSITION OF AMMONIA WITH WATER VAPOUR AS HEAT TRANSFER MEDIUM

(71) Applicants: thyssenkrupp Uhde GmbH, Dortmund (DE); thyssenkrupp AG, Essen (DE)

(72) Inventors: Alexander KLEYENSTEIBER, Wickede (Ruhr) (DE); Johannes ELISCHEWSKI, Dortmund (DE); Klaus NOELKER, Dortmund (DE)

(73) Assignees: thyssenkrupp Uhde GmbH, Dortmund (DE); thyssenkrupp AG, Essen (DE)

(21) Appl. No.: 19/490,316

(22) PCT Filed: Jun. 4, 2024
(86) PCT No.: PCT/EP2024/065287

§ 371 Date: Dec. 4, 2025

(30) Foreign Application Priority Data
Jun. 6, 2023 (DE) 10 2023 114 883.4
Jun. 6, 2023 (LU) LU 103144

(51) Int. Cl. C01B 3/047

(52) U.S. Cl. CPC C01B 3/047; C01B 2203/0277; C01B 2203/042; C01B 2203/0811; C01B 2203/0833

(57) ABSTRACT

In a plant and a method for producing H₂ by catalytic decomposition of NH₃, water serves as heat transfer medium for recovering process heat. The process heat is absorbed by water or steam and then released to NH₃, resulting in heating and evaporation of NH₃. The use of water or steam as heat transfer medium has benefits, including in terms of economic viability and safety.

The priority of Luxembourg patent application No. LU 103144 of Jun. 6, 2023, is claimed.

The invention relates to a plant and a method for producing H₂ by catalytic decomposition of NH₃. Water serves here as heat transfer medium for recovering process heat. The process heat is absorbed by water or steam and then released to NH₃, resulting in heating and evaporation of NH₃. The use of water or steam as heat transfer medium has benefits, including in terms of economic viability and safety.

H₂ can be obtained from H₂O by means of renewable energies and then converted with N₂ to NH₃. NH₃ can be stored and transported much more safely than H₂. NH₃ can then be broken down again to H₂ and N₂. After being separated from N₂, H₂ finds a wide range of industrial applications.

The decomposition of NH₃ to give N₂ and H₂ is an endothermic reaction (ΔH°=45.9 kJ·mol⁻¹) in which the molar amount is doubled (2 NH₃→N₂+3 H₂), and so the reaction is fundamentally favored by high temperatures and low pressures. The higher the pressure, the higher the temperature must be in order to achieve satisfactory reaction yields. A multitude of materials have been proposed as catalysts for the decomposition of NH₃, which are active at different temperatures (cf., for example, Il. Lucentini et al., Ind. Eng. Chem. Res. 2021, 60, 18560-18611).

The catalytic decomposition of NH₃ affords a product gas containing H₂ in a mixture with N₂ and possibly other gaseous components, e.g. undecomposed NH₃. However, many industrial applications require H₂ in high purity, and so purification of the product gas is required before H₂ can be delivered to industrial applications. While the cleaning of H₂ is fundamentally possible via various methods, e.g. cryogenic methods of membrane methods, cleaning by pressure swing adsorption is particularly economically viable on an industrial scale.

The catalytic decomposition of NH₃ to N₂ and H₂ takes place at high temperature and moderate pressure in the gas phase. Stored NH₃ is in liquid form in refrigerated tanks, at atmospheric pressure and −32.8 °C. A pump is used to feed NH₃ into the system at system pressure. The elevated system pressure causes the boiling point of the NH₃ to rise, for example to about 62.2° C. at 27.8 bara. In order to convert NH₃ to the gas phase, evaporation of the NH₃ requires the supply of heat.

Conventional processes for catalytic decomposition of NH₃ generate considerable amounts of heat, which can be used to evaporate NH₃.

U.S. Pat. No. 4,704,267 A relates to the production of high-purity H₂ from liquid anhydrous NH₃. NH₃ is evaporated and then split into its constituents. The resulting dissociated gas stream is fed to an adiabatic metal hydride cleaning unit in order to absorb the H₂ present in the stream. The adsorbed H₂ is then recovered as a high-purity product.

US 2022/170433 A1 relates to a reformer system comprising a vaporizer configured to vaporize liquid fuel to produce fuel gas; a reformer configured to reform the fuel gas produced by the vaporizer to produce a reformed gas containing hydrogen; an air supplier configured to supply air to the reformer; a fuel gas supplier configured to supply the fuel gas to the reformer; a heater configured to increase a temperature of the reformer; a reformed gas flow passage through which the reformed gas produced by the reformer flows; a cooler disposed in the reformed gas flow passage and configured to cool the reformed gas; a circulation passage connecting the vaporizer with the cooler, and through which refrigerant flows through the vaporizer and the cooler; and a circulation pump disposed in the circulation passage and configured to circulate the refrigerant through the circulation passage.

EP 4 067 298 A1 relates to a process for fueling of vehicle tanks with compressed hydrogen, comprising splitting ammonia into hydrogen and nitrogen in an ammonia cracking unit, compressing the hydrogen from the ammonia cracking unit, and dispensing the compressed hydrogen to the vehicle tanks in a hydrogen fueling unit comprising one or more dispensing units, wherein chilled ammonia is used to cool the compressed hydrogen before being dispensed to the vehicle tanks by heat exchange between the compressed hydrogen and the chilled ammonia, such that the chilled ammonia is heated, and the heated ammonia is transferred to the ammonia cracking unit.

FR 1 469 045 A relates to an apparatus consisting of a preheater fed with NH₃, a shell and tube system enclosing a catalyst for cracking of NH₃, and optionally a cell for cleaning of H₂ by diffusion, which are connected to one another and are within a single housing that contains heating means.

CN 111 957 270 A relates to an NH₃ decomposition apparatus comprising an NH₃ decomposition unit and a combustion unit that acts on the NH₃ decomposition unit. NH₃ enters the NH₃ decomposition unit via a first inlet for purified gas in order to perform a decomposition reaction of the NH₃. Mixed gas produced is discharged via a second outlet for purified gas and then enters the combustion unit via a second inlet for purified gas. The mixed gas comprises N₂, H₂ and undecomposed NH₃. The mixed gas enters the combustion unit in order to provide heat for the decomposition reaction of the NH₃ in the NH₃ decomposition unit, so as to achieve self-sufficiency with heat in the H₂ production system by NH₃ decomposition. No additional fuel is required for energy supply, and the costs of the H₂ production system by NH₃ decomposition are reduced.

CN 113 896 168 A relates to a process for producing H₂ or reducing gas by cracking NH₃ by a two-stage process comprising the following steps: The liquid NH₃ in the raw material is fully gasified and heated by a heat exchange gasification system, and then enters a heat-exchanging NH₃ cracking reaction system in the first stage, in order to generate a partial NH₃ cracking reaction. The reaction gas from the heat-exchanging NH₃ cracking reaction system in the first stage enters a high-temperature NH₃ cracking reaction system in the second stage, in order to perform a residual NH₃ cracking reaction. The high-temperature NH₃ cracking reaction gas from the second stage successively enters the heat-exchanging NH₃ cracking reaction system from the first stage and the heat-exchanging gasification system in order to recover heat gradually such that the reduction gas is obtained.

WO 2001/087770 A1 concerns the autothermal decomposition of NH₃ for production of high-purity H₂.

WO 2011/107279 A1 relates to an NH₃-based H₂ production reactor comprising an NH₃ cracking chamber with an NH₃ cracking catalyst, an internal combustion chamber with a combustion or oxidation catalyst which is in thermal contact with the NH₃ cracking chamber, an NH₃ gas preheating chamber and an outer shell ring for heat recovery from the combustion products leaving the combustion chamber, wherein the cracking chamber, the internal combustion chamber, the preheating chamber and the heat recovery shell ring are in a concentric arrangement.

WO 2017/160154 A1 relates to a method of generating energy with a gas turbine, comprising the following steps: (i) evaporating and preheating liquid NH₃ in order to produce preheated NH₃ gas; (ii) introducing the preheated NH₃ gas into an NH₃ cracking apparatus suitable for converting NH₃ gas to a mixture of H₂ and N₂; (iii) converting the preheated NH₃ gas into a mixture of H₂ and N₂ in the apparatus; (iv) cooling the mixture of H₂ and N₂ to obtain a cooled H₂ and N₂ mixture; (v) introducing the cooled H₂ and N₂ mixture into a gas turbine; and (vi) combusting the cooled H₂ and N₂ mixture in the gas turbine for energy generation.

WO 2019/038251 A1 relates to a process for producing an N₂- and H₂-containing product gas from NH₃, comprising the steps of noncatalytic partial oxidation of NH₃ with an O₂-containing gas to give a process gas containing N₂, water, amounts of nitrogen oxides and residual amounts of NH₃; cracking at least a portion of the residual amounts of NH₃ to H₂ and N₂ in the process gas by contact with a nickel-containing catalyst and simultaneously reducing the amounts of nitrogen oxides to N₂ and water by reaction with a portion of the H₂ formed during the cracking of the process gas by contact of the process gas with the nickel-containing catalyst; and drawing off the H₂- and N₂-containing product gas.

WO 2012/039183 A1 relates to an NH₃ decomposition apparatus that produces H₂ as a combustion improver, and to an NH₃ oxidation apparatus which reacts a portion of the NH₃ introduced with O₂ using an oxidation catalyst, which brings about combustion in order to provide the heat required for an NH₃ decomposition reaction.

WO 2012/090739 A1 relates to an H₂ generator comprising a decomposition apparatus which decomposes a compound containing a hydrogen atom and a nitrogen atom and generates H₂; a compound feed apparatus which feeds the compound to the decomposition apparatus; and an O₂ feed apparatus that feeds O₂ to the decomposition apparatus.

WO 2020/095467 A relates to an apparatus for producing H₂gas, comprising: an NH₃ evaporation device that heats liquid NH₃ in order to produce NH₃ gas; a main apparatus for thermal decomposition, which brings about the combustion of a fuel gas, whereby the NH₃ gas produced by the NH₃ evaporation apparatus is heated and decomposed to N₂ gas and H₂ gas; a cooler which cools a gas produced by the decomposition that contains the N₂ gas and the H₂ gas produced by the decomposition by the main apparatus for thermal decomposition; and a separator that separates the H₂ gas from the cooled gas produced by the decomposition.

WO 2021/257944 A1 relates to the recovery of H₂ from an NH₃ cracking process in which the cracking gas is cleaned in a PSA apparatus. The use of a membrane separator for the PSA offgas improves the recovery.

WO 2022/096529 A1 relates to a method of cracking of NH₃, for generating H₂ and for generating electric current, comprising electrolysis of water in supplied NH₃, evaporation, preheating and cracking of NH₃ using NH₃ synthesis catalysts at low temperatures.

WO 2022/243410 A1 relates to a method of synthesizing H₂ via the catalytic cracking of NH₃; wherein an NH₃-containing stream is subjected to a catalytic cracking step in the presence of heat in order to obtain a combusted gas and a thermally cracked stream containing N₂, H₂ and possibly residual NH₃, with or without water; wherein the thermally cracked stream is subjected to an H₂ recovery step in order to obtain a high-purity H₂ stream.

WO 2022/265647 A1 relates to the recovery of a renewable H₂ product from an NH₃ cracking method, in which the cracked gas is purified in a first PSA apparatus and at least some of the first PSA tail gas is recycled as fuel, in order to reduce the carbon intensity of the renewable H₂ product.

WO 2022/265648 A1 relates to the removal of NOx impurities by selective catalytic reduction (SCR) from a flue gas produced in an NH₃ cracking method using an aqueous NH₃ solution which is produced by cooling the compressed offgas from an H₂ PSA apparatus for cleaning the cracked gas.

WO 2022/265649 A1 relates to the reduction of the water content of the NH₃ used in an NH₃ cracking process, which enables the use of water-incompatible cracking catalysts. The process of water removal can also be used for recovery and recycling of NH₃ from the cracking gas.

WO 2022/265650 A1 relates to an NH₃ cracking process in which cracking gas is purified in a PSA system. Residual NH₃ in a first cracking gas is converted to further H₂ and N₂ by supplying PSA tail gas or a gas derived therefrom to a secondary cracking reactor and further processing a second cracking gas.

WO 2022/265651 A1 relates to a process in which residual NH₃ in an H₂ PSA system is removed from NH₃ cracking gas with a nonzeolitic adsorbent such as activated carbon, activated alumina or silica gel.

WO 2023/144335 A1 relates to a process for producing hydrogen by cracking ammonia, in which ammonia is cracked into hydrogen and nitrogen in the presence of a catalyst, wherein the ammonia is cracked without upstream noncatalytic oxidation in the absence of any oxidizing agent solely by supplying heat in the presence of the catalyst. According to one of several alternative possible process variants, the cracking of the ammonia is conducted in a reactor (18) analogous to a primary reformer, wherein the catalyst is arranged in at least one tube through which ammonia flows. Preferably a mixture of ammonia and hydrogen is combusted in the combustion chamber of the reactor (18), where the nitrogen formed in the reaction is an inert component that serves as an additional heat carrier. A mixture of hydrogen and ammonia is advantageous because it has a medium flame temperature, has better combustion properties than pure ammonia and, depending on the mixture ratio, emits less NOx than the two pure substances.

The methods known from the prior art for obtaining H₂ from NH₃ are not satisfactory in every respect, and there is a need for improved methods that can be implemented economically on an industrial scale.

For example, the prior art procedures have safety-related drawbacks. The heat transfer medium used for the preheating and evaporation of NH₃ is the process gas in the main process conduit or the flue gas. In these prior art methods, NH₃ absorbs heat directly from the process gas or flue gas in suitably interconnected heat exchangers. In both cases, the heat exchanger has the higher pressure on the side of the liquid or evaporating NH₃. If a heat exchanger should be damaged in such a process regime, for example suffer a ruptured pipe, which can certainly occur in the practical operation of industrial scale plants, then NH₃, as a result of the pressure gradient, would flow either into the main process conduit or into the flue gas, possibly in a considerable amount.

If NH₃ were to flow into the main process conduit in a considerable amount, the gaseous NH₃ would then be transferred therefrom into the plant for removal of H₂, for example into a pressure swing adsorption device. Although pressure swing adsorption devices can be configured for separation of polar substances such as NH₃, a significant increase in the amount applied can lead to a breakdown, as a result of which NH₃ would directly get into the product stream.

If NH₃ were to flow into the flue gas in a considerable amount, the NH₃ would be emitted into the environment through the chimney.

It is an object of the invention to provide an advantageous plant and an advantageous method for producing H₂ by catalytic decomposition of NH₃. The production of H₂ should be safe, economically viable and possible on an industrial scale.

This object is achieved by the subject matter of the claims.

It has been found that, surprisingly, water can preferably be used as heat transfer medium to heat and evaporate cooled liquid NH₃ (reactant).

According to the invention, NH₃ absorbs heat from heated water or steam in suitably interconnected heat exchangers and thus goes into the gas phase. Should a heat exchanger be damaged in the process regime of the invention, then NH₃ would be mixed with and possibly dissolved in the aqueous phase (about 1200 liters of NH₃ dissolve in one liter of water at 0° C., and about 500 liters of NH₃ at 23° C.). Any breakthrough into the product gas or into the flue gas is prevented efficiently in this way in accordance with the invention and hence the safety of the process regime is improved.

NH₃ is preferably stored cold, e.g. in a tank, and preferably enters the plant of the invention at −33 °C. NH₃ has to be warmed up and evaporated to perform the catalytic decomposition reaction. Preheating of the NH₃ up to its boiling point and subsequent evaporation is preferably accomplished using mid-pressure steam, or condensate thereof, which are preferably conducted in countercurrent to the NH₃. This procedure is advantageous with regard to the safety of the plant, since it prevents NH₃ immission into the flue gas or process gas in the event of damage to the heat exchanger involved (for example as a result of a ruptured pipe).

According to the invention, water serves as heat transfer medium for heating and evaporating of NH₃. Taking account of the pressure conditions, both water and NH₃ may each independently be liquid or gaseous (steam, NH₃ vapor). With regard to water as heat transfer medium, which releases heat to NH₃, it is appropriate to make the following distinction:
(a) steam, preferably mid-pressure steam, preferably with a pressure in the range from 10 to 40 bar and with a temperature in the range from about 180° C. to about 250° C.;
(b) hot liquid water, preferably with a temperature in the range from >44° C. to 90° C.;
(c) liquid heated cooling water at relatively high temperature, preferably with a temperature in the range from >32° C. to 44° C.; and
(d) liquid heated cooling water at relatively low temperature, preferably with a temperature in the range from 20° C. to 32 °C.

It has been found that measures for saving steam for the preheating and evaporation of NH₃ lead to an increase in the yield of H₂, provided that the resultant reduced amount of energy (released) is otherwise integrated back into the overall process. According to the invention, such a saving of steam is preferably achieved in that the amount of energy for preheating of the NH₃ is provided by other water streams, in particular by heated cooling water in liquid form, i.e. not in the form of steam. The NH₃ that has been preheated by absorption of heat from these water streams and is either still in liquid form or has already evaporated under the given pressure conditions can then subsequently be heated further by absorption of heat from steam, preferably from mid-pressure steam.

Thus, the NH₃ entering the plant is cold enough to utilize the cooling water obtained in the plant as a heat source.

In preferred embodiments, for this purpose, downstream of an NH₃ evaporation device of the invention in which steam releases heat to NH₃ and is condensed, the following are added to the resulting condensed steam:
(i) the blowdown which is obtained in the raising of steam in an H₂O evaporation device of the invention; and/or
(ii) surplus heated boiler feed water which is preheated by absorption of heat from product gas and/or flue gas, the surplus amount of which results from the fact that more boiler feed water is heated than is required for raising steam in an H₂O evaporation device of the invention.

The invention relates to a plant for producing H₂ by catalytic decomposition of NH₃, comprising
a combustion device for combustion of a combustion gas, generating heat of combustion and flue gas,
an NH₃ evaporation device for evaporation of liquid NH₃ by absorption of heat from heated water, preferably steam;
downstream of the NH₃ evaporation device in flow direction of the NH₃, an NH₃ decomposition device for catalytic decomposition of evaporated NH₃, with absorption of the heat of combustion generated in the combustion device and production of a product gas comprising H₂ and N₂;
downstream of the combustion device in flow direction of the flue gas, a flue gas heat exchanger for heating water, preferably for heating or raising steam, by absorption of heat from the flue gas; and/or, downstream of the NH₃ decomposition device in flow direction of the product gas, a product gas heat exchanger for heating water, preferably for heating or raising steam, by absorption of heat from the product gas; and
a conduit for the heated water from the flue gas heat exchanger and/or from the product gas heat exchanger to the NH₃ evaporation device.

The plant of the invention preferably comprises a device for purifying H₂, preferably a pressure swing adsorption device.

In preferred embodiments of the plant of the invention, the plant is designed for a throughput based on H₂ of at least 500 mol·h⁻¹, preferably at least 1000 mol·h⁻¹, more preferably at least 5000 mol·h⁻¹, even more preferably at least 10 000 mol·h⁻¹, most preferably at least 50 000 mol·h⁻¹, and in particular at least 100 000 mol·h⁻¹.

In preferred embodiments of the plant of the invention, the plant comprises a tank for liquid NH₃ that has a volume of at least 50 m³, preferably at least 100 m³, more preferably at least 500 m³, even more preferably at least 1000 m³, most preferably at least 5000 m³, and in particular at least 10 000 m³.

In preferred embodiments of the plant of the invention, the NH₃ decomposition device comprises at least three, preferably at least four, more preferably at least five, even more preferably at least six, most preferably at least seven and in particular at least eight catalyst beds, each of which comprises NH₃ decomposition catalyst; where each catalyst bed is preferably in a tube; where the catalyst beds are preferably connected in parallel.

In preferred embodiments of the plant of the invention, the NH₃ decomposition device comprises at least one catalyst bed which comprises NH₃ decomposition catalyst, wherein the length of the catalyst bed in flow direction for NH₃ is at least 1.0 m, preferably at least 1.5 m, more preferably at least 2.0 m, even more preferably at least 2.5 m, most preferably at least 3.0 m and in particular at least 3.5 m; where the catalyst bed is preferably in a tube.

In preferred embodiments of the plant of the invention, the combustion device comprises at least three, preferably at least four, more preferably at least five, even more preferably at least six, most preferably at least seven and in particular at least eight burners for combustion of the combustion gas.

In preferred embodiments of the plant of the invention, the flue gas heat exchanger and/or the product gas heat exchanger is a tube heat exchanger or shell and tube heat exchanger.

Preferably, the plant of the invention comprises a return conduit and a branching conduit for the residual gas mixture from the device for purification of H₂, preferably pressure swing adsorption device, to the combustion device.

The invention also relates to the use of a plant of the invention for production of H₂.

The invention additionally relates to a plant for producing H₂ by catalytic decomposition of NH₃, comprising the steps of:
(a) combusting a combustion gas to produce heat of combustion and flue gas;
(b) optionally, preheating NH₃ by absorption of heat from heated cooling water; preferably wherein the heated cooling water has previously absorbed heat from the product gas before implementation of a purification of H₂, preferably a pressure swing adsorption, and/or from H₂ after it has been compressed;
(c) optionally, preheating NH₃ by absorption of heat from water; and heating the water thus obtained by absorption of heat from the flue gas; preferably wherein the water is circulated;
(d) optionally, heating NH₃ by absorption of heat from water obtained by step (e);
(e) evaporating liquid NH₃ by absorption of heat from heated water, preferably steam;
(f) catalytically decomposing NH₃ evaporated in step (e), with absorption of heat of combustion generated in step (a) and production of a product gas comprising H₂ and N₂; and
(g) heating water, preferably heating or raising steam, by absorption of heat from the flue gas produced in step (a) and/or from the product gas produced in step (f); and introducing the heated water or the heated or raised steam into step (e).

Steps (b), (c) and (d) of the method of the invention are independently optional. Steps (a) to (g), if implemented, are preferably performed in alphabetical order.

In preferred embodiments of the method of the invention, in step (f), a throughput based on H₂ of at least 500 mol·h⁻¹ is achieved, preferably at least 1000 mol·h⁻¹, more preferably at least 5000 mol·h⁻¹, even more preferably at least 10 000 mol·h⁻¹, most preferably at least 50 000 mol·h⁻¹, and in particular at least 100 000 mol·h⁻¹.

In preferred embodiments of the method of the invention, in step (e), the liquid NH₃ is taken from a tank having a volume of at least 50 m³, preferably at least 100 m³, more preferably at least 500 m³, even more preferably at least 1000 m³, most preferably at least 5000 m³, and in particular at least 10 000 m³.

In preferred embodiments of the method of the invention, in step (f), the catalytic decomposition of NH₃ is effected in at least three, preferably at least four, more preferably at least five, even more preferably at least six, most preferably at least seven and in particular at least eight catalyst beds, each of which comprises NH₃ decomposition catalyst; where each catalyst bed is preferably in a tube; wherein NH₃ preferably flows through the catalyst beds in parallel.

In preferred embodiments of the method of the invention, in step (f), the catalytic decomposition is effected in at least one catalyst bed comprising NH₃ decomposition catalyst, where the length of the catalyst bed in flow direction for NH₃ is at least 1.0 m, preferably at least 1.5 m, more preferably at least 2.0 m, even more preferably at least 2.5 m, most preferably at least 3.0 m and in particular at least 3.5 m; where the catalyst bed is preferably in a tube.

In preferred embodiments of the method of the invention, in step (a), the combustion of the combustion gas is effected with the aid of at least three, preferably at least four, more preferably at least five, even more preferably at least six, most preferably at least seven and in particular at least eight burners.

In preferred embodiments of the method of the invention, the heating is effected in step (g) in a heat exchanger selected from tube heat exchangers and shell and tube heat exchangers.

According to the invention, the catalytic decomposition of NH₃ means the formation of N₂ and H₂, occasionally also referred to in the prior art as “cracking” of NH₃. Preferably in accordance with the invention, the catalytic decomposition of NH₃ is preferably effected in the absence of O₂.

Preferably, the invention comprises the following measures:
(i) evaporating NH₃;
(ii) catalytic decomposition of NH₃ with supply of heat to obtain a product gas comprising N₂, H₂ and any undecomposed NH₃ and H₂O;
(iii) recovery of heat;
(iv) optionally recovery of undecomposed NH₃;
(v) cleaning of H₂.
   Recovery of Heat for Evaporation of NH₃ with Water as Heat Transfer Medium

The inventive recovery of heat is an essential aspect of the invention because the catalytic decomposition of NH₃ takes place at elevated temperature in the gas phase and the residual heat obtained should be used with maximum efficiency for economic and environmental reasons.

According to the invention, heat is provided by combustion of a combustion gas in a combustion device. A first portion of the heat formed in the combustion preferably flows into an NH₃ decomposition device in which the NH₃ decomposition catalyst is present, for example in the form of one or more catalyst beds. The endothermic catalytic decomposition of NH₃ takes place therein. A second portion of the heat formed in the combustion preferably leaves the combustion device with the flue gas and enters a flue gas duct.

According to the invention, available sources for the recovery of heat are accordingly as follows:
the hot product gas leaving the NH₃ decomposition device, and
the hot flue gas leaving the combustion device.

The hot product gas typically accounts for a greater mass flow than the hot flue gas, but the temperature of the product gas is typically lower than the temperature of the flue gas. By means of efficient heat integration, heat can be taken firstly from the product gas and secondly from the flue gas to an appropriate extent, which increases the overall yield.

The heat transfer medium used in accordance with the invention for the transfer of heat from product gas or flue gas to NH₃ for the purpose of heating and evaporation thereof is heated water, preferably steam.

The steam is preferably raised in an H₂O evaporation device which preferably comprises a steam drum and a heat exchanger that are actively connected to one another. In a preferred embodiment, the H₂O evaporation device comprises, as well as the steam drum, the product gas heat exchanger in which water absorbs heat from the product gas. In another preferred embodiment, the H₂O evaporation device comprises, as well as the steam drum, the flue gas heat exchanger in which water absorbs heat from the flue gas. In a further preferred embodiment, the H₂O evaporation device comprises, in addition to the water steam drum, both the product gas heat exchanger in which water takes heat from the product gas and the flue gas heat exchanger in which water absorbs heat from the flue gas.

Steam can be raised by supplying the steam drum with boiler feed water. If more boiler feed water is supplied than steam is removed, the result is a surplus of heated boiler feed water, which can be separated from the steam and utilized like other heated cooling water too, in particular for heating NH₃.

Heat present in the hot product gas and/or flue gas is preferably absorbed here by the water, which results in heating or raising of steam. The steam is fed into the NH₃ evaporation device via a conduit system, where NH₃ absorbs heat from the steam, is heated and ultimately itself evaporates.

In a preferred embodiment, boiler feed water is preheated in the flue gas duct, then a bypass stream is diverted therefrom and the remaining residue of the preheated boiler feed water is directed into the steam drum.

In another preferred embodiment, no bypass stream is diverted, and the entire amount of preheated boiler feed water is directed into the steam drum. Preferably, any surplus is then discharged from the steam drum in a liquid boiling state. In this way, more heat can be taken from the process gas (flue gas or product gas), which may be beneficial if surplus heat is available therein.

After leaving the NH₃ evaporation device, the heated and evaporated NH₃ is then heated to an even higher temperature level, as is desirable or necessary for the catalytic decomposition of NH₃, and finally fed to the NH₃ decomposition device.

In an economically viable process regime, only moderate temperature levels are achievable with steam for the heated NH₃ (<300° C.). Therefore, proceeding from a moderate temperature level attained with the aid of steam, for the further heating of NH₃ up to a high temperature level (>300° C.), at least one heat exchanger is then preferably used in accordance with the invention, preferably at least two heat exchangers, in which the NH₃ absorbs heat from the hot product gas and/or the hot flue gas.

Additional heat required to attain the desired decomposition temperature or to maintain the endothermic catalytic decomposition, preferably in accordance with the invention, is supplied directly by a heat flow from the combustion device into the NH₃ decomposition device. For this purpose, the NH₃ decomposition device and the combustion device preferably together form a reactor designed analogously to a primary reformer.

The inventive recovery of heat can preferably fulfill the following functions, for example:
preheating of water (e.g. boiler feed water);
preheating of NH₃;
raising of steam;
evaporation of NH₃; and
preheating of combustion air.

According to the invention, there are various combination options available for the arrangement of the plant parts for recovery of heat.

Preferably, heat present in the flue gas stream of the combustion device and/or heat present in the product gas stream of the NH₃ decomposition device is utilized in at least three, preferably in at least four, more preferably in at least five, heat exchangers arranged in succession in flow direction of the flue gas stream or product gas stream, preferably for different part-operations of the process.

There follows a detailed elucidation of the evaporation of NH₃ with the NH₃ evaporation device of the invention and a preferred preheater.

In the NH₃ evaporation device, NH₃ absorbs heat from water, preferably steam, and goes into the gas phase. Preferably, the temperature of the NH₃ on entry into the NH₃ evaporation device is in the range of about 60±30° C., more preferably about 60=15° C. Preferably, the temperature of the NH₃ on exit from the NH₃ evaporation device is in the range of about 60±30° C., more preferably about 60±15 °C.

There is preferably at least one heat exchanger downstream of the NH₃ evaporation device in flow direction of the NH₃, which is either the product gas heat exchanger or the flue gas heat exchanger. There are preferably at least two heat exchangers downstream of the NH₃ evaporation device in flow direction of the NH₃, which are the product gas heat exchanger and the flue gas heat exchanger. The heated water, preferably steam, supplied as heat source for the operation of the NH₃ evaporation device is generated in the product gas heat exchanger by absorption of heat from the product gas and/or in the flue gas heat exchanger by absorption of heat from the flue gas. The heat in the product gas and/or flue gas is utilized for heating or raising of steam in an H₂O evaporation device and this steam is supplied to the NH₃ evaporation device.

Preferably, the steam is utilized in turn, optionally in the form of steam condensate, after exiting from the NH₃ evaporation device, specifically as heating medium in an NH₃ preheating and NH₃ evaporation.

This is preferably done in an at least two-stage process in which NH₃ and steam, or steam condensate thereof, are conducted in countercurrent. On the basis of the ratio between the enthalpy of condensation of the steam and free enthalpy of the steam condensate thereof, the condensation of the steam alone may not be sufficient to evaporate the NH₃ if the steam condensate is to be released at an acceptable temperature of 40° C., for example. Therefore, preference is given in accordance with the invention to using a preheater in which there may even already be partial commencement of the evaporation of the NH₃.

Preferably, the preheater is upstream of the NH₃ evaporation device in flow direction of the NH₃, in order to preheat NH₃. In the preheater, NH₃ absorbs heat from water, preferably steam condensate. Preferably, the temperature of the NH₃ on entry into the preheater is in the range of about −35±10° C., more preferably about −35±5 °C. Preferably, the temperature of the NH₃ on exit from the preheater is in the range of about 60±30° C., more preferably about 60±15 °C.

The steam flow rate is preferably adjusted such that essentially only steam condensate leaves the NH₃ evaporation device. In preferred embodiments, blowdown and/or boiler feed water, for example from a bypass, can be mixed into this steam condensate (see below).

Preferably, raised steam and raised steam condensate are directed in countercurrent through the preheater and the NH₃ evaporation device.

The NH₃ passes through the preheater, in which NH₃ absorbs heat in countercurrent from steam condensate. The energy input is high enough to heat the NH₃ to boiling point and to already partly evaporate. There is preferably already evaporation in the preheater of at least 5%, more preferably at least 10%, even more preferably at least 15%, most preferably at least 20% and in particular at least 25% of the total flow rate of NH₃. For example, the steam content of the NH₃ may be up to 35%.

The preheater preferably contains an apparatus for separating off the two NH₃ phases, such that the as yet unevaporated residue of the NH₃ enters the NH₃ evaporation device at boiling temperature, and the gaseous NH₃ is transported in a separate pipeline.

Alternatively, both phases of the NH₃ may also enter the NH₃ evaporation device in a common pipeline.

Steam serves as a heating medium in the NH₃ evaporation device, for example saturated steam at 33.5 bar a and a temperature of 239.8 °C. The steam ensures complete evaporation of the NH₃, preferably likewise again via a device integrated into the heat exchanger for separation of the two phases. The two gaseous NH₃ streams are preferably combined and directed further into the process.

Water or steam that has previously absorbed heat from the flue gas and/or product gas is used for the above-described NH₃ evaporation device and any preheater.

Preferably in accordance with the invention, heat from heated cooling water is additionally utilized for heating of NH₃.

Heated cooling water which is preferably used in accordance with the invention for heating of NH₃ is preferably obtained in
the cooling of the product gas with the aid of a process cooler upstream of an apparatus for purification of H₂ in flow direction of the product gas, preferably a pressure swing adsorption device;
the cooling of the steam condensate with the aid of a steam condensate heat exchanger downstream of the NH₃ evaporation device and preferably downstream of any preheater, in flow direction of the steam condensate;
the cooling of the H₂ product with the aid of a heat exchanger downstream of an H₂ compressor in flow direction of the H₂ product, and upstream of any second H₂ compressor; and/or
the cooling of the flue gas with the aid of a flue gas heat exchanger in the flue gas duct.

In preferred embodiments of the invention, the yield of H₂ is increased in that the amount of steam raised is reduced in relative terms and the smaller amount of heat consequently required remains within the process, which means that less combustion gas is required. The energy gap with regard to the preheating and evaporation of NH₃ that results from the relatively smaller amount of steam provided is preferably closed by preheating of NH₃ with the heated cooling water.

For this purpose, there is preferably a preheating device downstream of the tank and upstream of the NH₃ evaporation device in flow direction of the NH₃, preferably also upstream in flow direction of the NH₃ of any preheating device which preferably serves to preheat the NH₃ and in which NH₃ absorbs heat from water that has in turn previously been obtained beforehand elsewhere as heated cooling water.

Preferably, the heated cooling water is taken from a process cooler in flow direction of the product gas upstream of an apparatus for purification of H₂, preferably a pressure swing adsorption device, where it has absorbed heat beforehand from the product gas. Preferably, the heated cooling water is additionally or alternatively taken from a heat exchanger of any H₂ compressor, where it has absorbed heat beforehand from compressed H₂. Preferably, the heated cooling water is additionally or alternatively taken from a steam condensate heat exchanger downstream of the NH₃ evaporation device.

Preference is additionally given to utilizing heat from the condensed steam, i.e. the steam condensate is cooled before it is returned to the processing. For this purpose, there is preferably a steam condensate heat exchanger downstream of the NH₃ evaporation device in flow direction of the steam condensate.

If there is a preheater upstream of the NH₃ evaporation device, the steam condensate heat exchanger is preferably downstream of the preheater in flow direction of the steam condensate. The steam condensate then preferably leaves the NH₃ evaporation device first and is returned to the preheater in which NH₃ absorbs heat from the steam condensate and is thus preheated. The steam condensate then enters the steam condensate heat exchanger, in which cooling water absorbs heat from the steam condensate. The cooling water heated in this way can be utilized elsewhere, for example for preheating of liquid NH₃.

In addition, the flue gas may also be cooled with cooling water. This may be advisable, for example, when there is no H₂ compressor and hence there is not enough heated cooling water available to apply the required amount of heat for the preheating and evaporating of the NH₃.

The sources for heated cooling water that are preferred in accordance with the invention are illustrated in FIG. 11, where it is possible in accordance with the invention that only one of these sources, that two or more of these sources or that all of these sources are used for preheating and optionally evaporating of NH₃.

The preliminary temperature with which fresh, i.e. as yet unheated, cooling water is typically supplied depends on the climate of the site. The cooling water removes process heat in that it is heated by a temperature differential of typically about 8° C. to about 15 °C. The heat absorbed by cooling water is then preferably used for preheating of liquid NH₃ (cf. FIG. 7).

The temperature of the cooling water or heated cooling water is thus preferably well below the temperature of the water or steam which is used in the NH₃ evaporation device of the invention for evaporation of NH₃. Preferably, the temperature of the heated cooling water is at most 100° C., more preferably at most 80 C, even more preferably at most 60 °C. For example, on the Arabian Peninsula a cooling water return temperature of about 50° C. can be expected, in Central Europe closer to about 30 °C.

As already mentioned, a distinction is made in accordance with the invention between liquid heated cooling water at relatively high temperature (preferably >32° C. to 44° C.) on the one hand, and liquid heated cooling water at relatively low temperature (preferably 20° C. to 32° C.) on the other.

If liquid heated cooling water at relatively low temperature is used for heating of NH₃, it is preferable in accordance with the invention to use a heat exchanger to produce this liquid heated cooling water at relatively low temperature in the flue gas duct (FIGS. 10, 14 and 16, further heat exchanger 71) and hence preheat the NH₃ to its boiling point. The subsequent evaporation of the NH₃ thus heated is then preferably achieved solely by heat from the steam condensate.

If liquid heated cooling water at relatively high temperature is used to heat NH₃, the NH₃ can thus be preheated to distinctly higher temperatures. In this case, a heat exchanger may be provided in the flue gas duct for absorption of heat from the flue gas. This is advisable especially when there is no H₂ compressor, and so there is also no heat exchanger downstream of the H₂ compressor in which heated cooling water at relatively high temperature would otherwise be generated. Alternatively, there is such an H₂ compressor. In this case, a heat exchanger downstream of the H₂ compressor or between two or more H₂ compressors preferably provides a sufficient amount of heated cooling water at relatively high temperature.

If, for example, preheating and evaporation of NH₃ requires a total power of 709 kW, 409 kW can be applied without use of heated cooling water, for example, through the condensation of steam, and the remaining 300 kW through heat transfer from steam condensate. With a sufficiently large amount of cooling water (warmed up, for example, from 25° C. to 35° C.), it is possible to achieve pre-heating of NH₃ with a power of 115 kW, which brings the NH₃ to a temperature of 12 °C. For the preheating it is then only necessary to apply a power of 252 kW, and for the evaporation a power of 342 kW. By suitable integration of the heat thus released in the process gas, it is possible to achieve an increase in the yield of the plant by 0.4 to 0.5%, for example.

In addition, preferably in accordance with the invention, heating of NH₃ is accomplished with additional utilization of heat from water that absorbs heat from the flue gas, then transfers this heat to NH₃ for preheating, then absorbs heat again from the flue gas, etc. The water is thus preferably circulated for this purpose.

Hot water (>44-90° C.) or heated cooling water preferably does not serve to evaporate the NH₃, but only to preheat it to boiling point. In the case of preheating, a slightly higher temperature of the heat transfer medium of only 10 K in relative terms can still lead to an economic design of a heat exchanger. In contrast, in the course of an evaporation, the heat transfer medium should be at least 40 K hotter in relative terms at its coldest point. For this purpose, the hot water or the heated cooling water would have to have a distinctly higher temperature, i.e. heat would have to be taken from the flue gas and/or product gas at a higher temperature in order to produce it. Preferably in accordance with the invention, however, heated cooling water is produced by utilizing specifically the low temperature levels, in particular the low temperature levels of the flue gas, and there is thus consequently preferably solely preheating of NH₃, but not additionally also evaporation.

In preferred embodiments of the invention, for this purpose, downstream of the tank and upstream of the NH₃ evaporation device in flow direction of the NH₃, preferably downstream of any preheating device in flow direction of the NH₃, preferably upstream of any preheater in flow direction of the NH₃, there is an additional heat exchanger which preferably serves to preheat the NH₃ and in which NH₃ absorbs heat from water which is preferably circulated and which has absorbed heat beforehand from the flue gas.

For this purpose, the additional heat exchanger is preferably functionally connected to another heat exchanger. The further heat exchanger is preferably downstream of the flue gas heat exchanger in flow direction of the flue gas and serves to heat the water by absorption of heat from the flue gas. Preferably, the additional heat exchanger and the further heat exchanger are connected to one another via a loop through which the water is circulated, preferably with a pump.

The temperature of this water or heated water is thus preferably well below the temperature of the water or steam which is used in the NH₃ evaporation device of the invention for evaporation of NH₃. Preferably, the temperature of the heated water (i.e. after absorption of heat from the flue gas) is not more than 110° C., more preferably not more than 100° C., even more preferably not more than 90 °C.

Even after passing through several heat exchangers in which it has released heat to water or NH₃ as heat transfer medium and hence has been cooled, the flue gas is typically at a comparatively high temperature of, for example, about 150 °C. This is because, if the flue gas falls below a temperature of about 120° C., the preheating of the combustion air in a heat exchanger in the flue gas duct by absorption of heat from the flue gas would no longer be satisfactory, since a relatively high temperature differential is required therefor (cf. FIGS. 8 and 9, heat exchanger 43). The residual heat present in the flue gas cannot therefore be integrated into process streams.

The flue gas additionally contains a high content of N₂: A proportion of N₂ is released in the combustion of NH₃. A proportion of N₂ is present in the combustion air. A proportion of N₂ is generated in the catalytic decomposition of NH₃ and optionally returned from a device for purification of H₂, preferably a pressure swing absorption device, to the combustion device. Owing to the high content of N₂, the dew point of the flue gas is very low under the prevailing pressure conditions, for example at about 60 °C. In order to avoid condensation, which could lead to damage to the heat exchangers mounted in the flue gas duct, according to the invention, a temperature differential of 25° C. is preferably observed as a safety margin from the dew point.

Preferably, this residual heat in the flue gas (temperature range from about 85° C. to about 120° C.) is utilized in that it is absorbed by the water circulating in the circuit. It is for this purpose that the additional heat exchanger is preferably provided in the flue gas duct, with circulation of water as heat transfer medium through said additional heat exchanger, preferably driven by a pump (cf. FIG. 10).

The water is heated in this additional heat exchanger, for example from about 40° C. to about 90° C., and can then serve as heat source for NH₃, which has advantageously already been preheated by the cooling water.

For example, at an exit temperature of the flue gas of 90° C. (cf. FIG. 16), which is compliant with the margin criterion from the dew point, a power of 101 kW is absorbed and used to heat NH₃ until the boiling point of the NH₃ is attained. The preheater downstream in flow direction of the NH₃ increases the proportion of the evaporated NH₃ to about 34%. For the NH₃ evaporation device used in the fourth stage only a power of, for example, 320 kW is required in that case. Compared to two-stage heating and evaporation of NH₃, the amount of heat required to produce the steam can be almost halved in this way. For instance, the yield in relation to the amount of H₂ produced can be increased by, for example, about 0.3%.

The use of water or steam for the preheating, heating and evaporation of the initially liquid NH₃ is advantageous economically and for safety purposes compared to the direct use of flue gas or process gas as heat source for the evaporation of NH₃, which is likewise possible in principle. Damage to a pipe could cause NH₃ to flow into the offgas and hence into the atmosphere, or get into the process stream. Electrical evaporation of water to produce steam would lead to high energy consumption and associated costs.

In terms of safety and economic viability, water is therefore advantageous as heat transfer medium.

According to the invention, the steam is preferably at a somewhat higher pressure than the NH₃, such that, in the event of damage to a heat exchanger (e.g. by pipe rupture), any steam would flow into the NH₃. Owing to the comparatively small pressure differential, however, the inflow of water would be small.

In the NH₃ evaporation device, the low density of the steam would result in a comparatively low mass inflow, but also the comparatively high temperature of the steam would also result in a significant inflow of energy. As a result, elevated evaporation of NH₃ would occur. However, since the NH₃ evaporation device and the heat exchanger integrated therein are intended and designed to evaporate NH₃, any such increase in evaporation of NH₃ would be less critical.

In any preheater, the mass inflow from the water would be higher owing to the higher density, but the energy inflow would be lower.

NH₃ evaporation devices preferred in accordance with the invention and preheaters preferred in accordance with the invention are independently equipped to draw off any water (high boiler) present in the NH₃ as blowdown, and so, in such a case, there might be no breakthrough at all of water into the process.

If steam should enter the process, the water would be inert in the decomposition of NH₃ and, just like NH₃, would break through the apparatus for purification of H₂ (preferably pressure swing adsorption device) in relatively high concentrations. The presence of water in the H₂ product is less hazardous to end users.

In contrast to the inventive use of water as heat transfer medium, the NH₃ would instead have the higher pressure in the case of conventional use of process heat directly from the product gas or the flue gas for evaporation of NH₃. Compared to the product gas or flue gas, there would be a clear pressure differential, such that, in the event of damage to a heat exchanger (e.g. by pipe rupture), a high mass inflow would occur as a result of the high pressure differential and the high density of the liquid NH₃. Breakthrough of NH₃ into the flue gas would result in emissions through the stack and considerable pollution of the environment. A breakthrough of NH₃ into the product gas would transfer the NH₃ into the H₂ product, which could quite possibly be hazardous to end users.

Evaporation of NH₃ is preferably accomplished using at least two heat exchangers in which NH₃ is first preheated to the boiling point and then evaporated.

In order to improve safety, the preheating, heating and evaporation of the NH₃ is decoupled in accordance with the invention from the decomposition of the NH₃ and the continuation of the process pathway.

### Streams

Preferred embodiments of the invention are elucidated hereinafter with reference to the various streams that are used or formed with preference in the performance of the method of the invention or in the operation/use of the plant of the invention. For this purpose, the following streams are appropriately distinguished hereinafter:
NH₃:
   from storage up to catalytic decomposition;
   catalytic decomposition;
combustion gas;
combustion air;
product gas:
   after catalytic decomposition up to purification of H₂;
   removal of residual amounts of undecomposed NH₃;
   purification of H₂ and removal of residual gas mixture;
H₂-after purification up to storage;
residual gas mixture;
flue gas; and
water or steam.

The following elucidations are likewise applicable to the plant of the invention, to the inventive use of the plant, and to the method of the invention. Reference is made here in some cases to the figures in order to illustrate an integration that is possible and may be preferred in accordance with the invention of individual components or steps into the plant of the invention or the method of the invention. But this does not mean that all other components or associated steps that are shown in the respective figures must necessarily be implemented at the same time. The references to the figures should not be interpreted in a restrictive manner, but serve merely to illustrate isolated preferred embodiments of the invention.

NH₃—from Storage to Before Catalytic Decomposition

In accordance with the invention, the NH₃ is preferably stored as starting material.

The stored NH₃ is preferably in liquid form in a cooled tank at atmospheric pressure and a temperature below its boiling temperature of −33.5 °C. A pump is used to feed NH₃ into the plant at plant pressure. The elevated plant pressure increases the boiling point of the NH₃. In order to convert NH₃ to the gas phase, evaporation of the NH₃ requires the supply of heat. The evaporation of NH₃ requires significant amounts of heat. At a pressure of 30 bar, for example, about 2.4 t/h NH₃ can be preheated and evaporated per megawatt of energy input.

Before the NH₃ can be catalytically decomposed, it is preferably heated successively to multiple temperature levels in accordance with the invention.

Proceeding from liquid NH₃, NH₃ is heated and then evaporated to an average temperature level (<300° C.) by absorption of heat from water or steam.

This is preferably followed by further heating of NH₃ to a high temperature level (>300° C.) by absorption of heat directly from flue gas and/or product gas, i.e. without water as heat transfer medium. In the case of these subsequent measures for further heating to a high temperature level (>300° C.), the pressure differentials and density of the NH₃ in the heat exchangers are much lower than in the case of the previous measures for heating and evaporation of NH₃ to a moderate temperature level (<300° C.). Any damage to the heat exchangers (e.g. ruptured pipes) would therefore entail far less serious safety problems in the case of the subsequent measures (temperature level >300° C.) than in the case of the previous measures (temperature level <300° C.).

The energy integration brings preferably NH₃ to the desired temperature on entry into the NH₃ decomposition device. In addition, the combustion air is preferably also preheated. It is advantageous here to preheat and evaporate water or boiler feed water. Since the process heat is present in two strands, firstly in the product gas and secondly in the flue gas, the heat exchangers may be arranged in accordance with the invention in different variants.

Preferably in accordance with the invention, liquid NH₃ is evaporated by absorption of heat from the steam. This hot steam is in turn generated from water or lower-temperature steam.

For the purposes of the description, the term “water”, unless expressly stated otherwise, is used for all its states of matter, in which case, depending on the temperature and pressure, this water may be in liquid or gaseous form or in the form of a biphasic system, i.e. possibly even as steam. This is likewise applicable to “NH₃”.

Preferably, the water absorbs heat from flue gas downstream of the combustion device in flow direction of the flue gas and/or heat from product gas downstream of the NH₃ decomposition device in flow direction of the product gas. For this purpose, suitable heat exchangers are preferably provided and interconnected in the plant of the invention.

Depending on the reaction temperature, the amount of heat present in the product gas may be smaller than the heat present in the combustion gas. This can have an effect on heat recovery. At comparatively low temperatures at the exit from the NH₃ decomposition device (e.g. about 500° C.), the amount of heat in the product gas is distinctly lower than in the flue gas. In such a case, in accordance with the invention, the steam raising is preferably performed mainly or entirely with heat from the flue gas from the combustion device. Although this variant of the interconnection of the components for heat recovery has the disadvantage of a lower temperature gradient between flue gas and water fed in, this can possibly be compensated for by a larger NH₃ evaporation device or a reduction in the pressure level.

It may also be preferable in accordance with the invention to provide two NH₃ evaporation devices, which may be connected in parallel. In that case, the NH₃ is preferably optionally first heated in a preheater and then directed via two mutually parallel conduits in each case into a first NH₃ evaporation device and a second NH₃ evaporation device. The second NH₃ evaporation device may preferably be supplied with steam, while the first NH₃ evaporation device is supplied with steam condensate. After passing through the first evaporation device, the steam condensate preferably reaches the preheater and likewise flows through it with release of heat.

In preferred embodiments of the invention, water absorbs heat from the flue gas in at least one first heat exchanger and at least one second heat exchanger downstream of the combustion device in flow direction of the flue gas, where the flue gas is at a higher temperature when it flows through the first heat exchanger than when it flows through the second heat exchanger (cf. FIG. 10; first heat exchanger: flue gas heat exchanger 52; second heat exchanger: further heat exchanger 71).

Stations preferred in accordance with the invention through which the NH₃ preferably passes on the way from the tank to the NH₃ decomposition device are elucidated hereinafter.

In preferred embodiments of the invention, liquid NH₃ leaves a tank and is fed into the plant with a pump at plant pressure. In order to evaporate the NH₃, the NH₃ evaporation device, in flow direction of the NH₃, is downstream of the tank in which NH₃ absorbs heat from steam that in turn has absorbed heat from product gas and/or flue gas beforehand (cf. FIGS. 1-10, NH₃ evaporation device 14).

There is preferably a preheater downstream of the tank and upstream of the NH₃ evaporation device in flow direction of the NH₃, which preferably serves to heat the NH₃ to the desired temperature on entry to the NH₃ evaporation device, and in which NH₃ absorbs heat from water which in turn has left the NH₃ evaporation device beforehand as steam condensate. Preferably, steam and steam condensate are directed in countercurrent through the preheater and the NH₃ evaporation device (cf. FIGS. 4-10, preheater 13).

There is preferably a first heat exchanger downstream of the NH₃ evaporation device in flow direction of the NH₃, which preferably serves to further heat the NH₃ and in which NH₃ preferably absorbs heat from product gas (cf. FIGS. 8 and 9, heat exchanger 20).

There is preferably a second heat exchanger downstream of the first heat exchanger in flow direction of the NH₃, which preferably serves to further heat the NH₃ and in which NH₃ preferably absorbs heat from flue gas (cf. FIGS. 8 and 9, heat exchanger 22).

In preferred embodiments of the invention, when the catalytic decomposition of the NH₃ takes place in two stages in a first NH₃ decomposition device (preliminary reactor) and a second NH₃ decomposition device, there is preferably a further heat exchanger downstream of the first NH₃ decomposition device (preliminary reactor) and preferably upstream of the second NH₃ decomposition device in flow direction of the NH₃, which is preferably used for heating of the intermediate product gas after it leaves the first NH₃ decomposition device (preliminary reactor) and before it enters the second NH₃ decomposition device (together with combustion device analogous to a primary reformer), and in which NH₃ preferably absorbs heat from flue gas (cf. FIG. 9, further heat exchanger 67).

In preferred embodiments of the invention, there is a preheating device downstream of the tank and upstream of the NH₃ evaporation device in flow direction of the NH₃, preferably also upstream of any preheater in flow direction of the NH₃, which preferably serves to preheat the NH₃ and in which NH₃ absorbs heat from water which in turn has previously been obtained elsewhere as cooling water, preferably in a process cooler upstream of an apparatus for purification of H₂ in flow direction of the product gas, preferably a pressure swing adsorption device, or in a heat exchanger of an H₂ compressor (cf. FIGS. 7 and 10, preheating device 70).

In preferred embodiments of the invention, downstream of the tank and upstream of the NH₃ evaporation device in flow direction of the NH₃, preferably downstream of any preheating device in flow direction of the NH₃, preferably upstream of any preheater in flow direction of the NH₃, there is an additional heat exchanger which preferably serves to preheat the NH₃ and in which NH₃ absorbs heat from water which is preferably circulated and which has absorbed heat beforehand from the flue gas (cf. FIG. 10, additional heat exchanger 73).

Preferably in accordance with the invention, liquid NH₃ is preferably heated in at least one stage, more preferably in at least two stages, even more preferably in at least three stages, especially preferably in at least four stages, and converted from the liquid phase to the gas phase, i.e. evaporated. The NH₃ here preferably in each case attains a moderate temperature level (<300° C.).

In the case of single-stage heating and evaporation, the liquid NH₃ is preferably heated in a single stage and does indeed evaporate immediately (cf. FIGS. 1 to 3). In preferred embodiments of the invention, at least one heat exchanger is provided and interconnected for the purpose (cf. FIG. 1, flue gas heat exchanger 52; FIG. 2, product gas heat exchanger 26). In other preferred embodiments of the invention, at least two heat exchangers are provided and interconnected for the purpose (cf. FIG. 3, product gas heat exchanger 26 and flue gas heat exchanger 52).

In the case of two-stage heating and evaporation, the NH₃ is preferably first heated (but not yet fully evaporated) in a first stage and then evaporated in a second stage (cf. FIGS. 4 to 6, 8, 9). In preferred embodiments of the invention, for this purpose, at least one heat exchanger is provided and interconnected for the first stage and at least one heat exchanger is likewise provided and interconnected for the second stage (cf. FIG. 4, stage 1: preheater 13; stage 2: product gas heat exchanger 26 or flue gas heat exchanger 52). In other preferred embodiments of the invention, for this purpose, at least one heat exchanger is provided for the first stage and at least two heat exchangers are provided for the second stage (cf. FIGS. 5, 6, 8 and 9, stage 1: preheater 13; stage 2: product gas heat exchanger 26 and flue gas heat exchanger 52).

In the case of three-stage heating and evaporation, the liquid NH₃ is preferably preheated (but not yet fully evaporated) in a first stage, then additionally heated (but likewise not yet fully evaporated) in a second stage and then evaporated in a third stage (cf. FIG. 7).

In preferred embodiments, the ratio of enthalpy of condensation and latent heat of the steam condensate is such that the preheater, even in two-stage operation, already evaporates a certain portion of the NH₃. If the intention were to use the preheater exclusively for preheating, in order to achieve the evaporation of NH₃ exclusively via the enthalpy of condensation of the steam, the amount of steam would have to be increased considerably, and the steam condensate would exit at a very high remaining temperature, which would be disadvantageous.

In preferred embodiments of the invention, for this purpose, at least one heat exchanger is provided and interconnected for the first stage, at least one heat exchanger is likewise provided and interconnected for the second stage, and at least one heat exchanger is also provided and interconnected for the third stage (cf. FIG. 7, stage 1: preheating device 70; stage 2: preheater 13; stage 3: product gas heat exchanger 26 or flue gas heat exchanger 52). In other preferred embodiments of the invention, for this purpose, at least one heat exchanger is provided and interconnected for the first stage, at least one heat exchanger is likewise provided and interconnected for the second stage, and at least two heat exchangers are provided and interconnected for the third stage (not shown as a figure; corresponds to a variation of FIG. 5 or 6 via the embodiment according to FIG. 7; stage 1: preheating device 70; stage 2: preheater 13; stage 3: product gas heat exchanger 26 and flue gas heat exchanger 52). Three-stage heating and evaporation the liquid NH₃ can likewise be inferred from FIG. 10, when either preheating device 70 is absent or if the additional heat exchanger 73 is absent.

In the case of four-stage heating and evaporation, the liquid NH₃ is preferably first preheated (but not yet fully evaporated) in a first stage, then additionally warmed (but likewise not yet fully evaporated) in a second stage, then heated (but likewise not yet fully evaporated) in a third stage and then evaporated in a fourth stage (cf. FIG. 10). In preferred embodiments of the invention, for this purpose, at least one heat exchanger is provided and interconnected for the first stage, at least one heat exchanger is likewise provided and interconnected for the second stage, at least one heat exchanger is also provided and interconnected for the third stage, and at least one heat exchanger, preferably at least two heat exchangers, is/are also provided and interconnected for the fourth stage (cf. FIG. 10, stage 1: preheating device 70; stage 2: additional heat exchanger 73; stage 3: preheater 13; stage 4: product gas heat exchanger 26 (not shown) and flue gas heat exchanger 52).

Once the NH₃ has been heated and evaporated, it has preferably reached a moderate temperature level (<300° C.).

It is preferable in accordance with the invention to further heat NH₃ up to a high temperature level (>300° C.) by absorption of heat directly from flue gas and/or product gas. For this purpose, heat is absorbed in at least one heat exchanger from the product gas downstream of the NH₃ decomposition device in flow direction of the product gas and/or from the flue gas downstream of the combustion device in flow direction of the flue gas.

In preferred embodiments of the invention, NH₃ is first heated up further by absorption of heat from the product gas in a first heat exchanger provided and interconnected for the purpose. The first heat exchanger is preferably downstream of the NH₃ decomposition device in flow direction of the product gas; the streams flowing through it are firstly the hot product gas and secondly the NH₃ to be heated further. Heat recovered from the product gas is thus used for further heating of NH₃ (cf. FIGS. 8 and 9, heat exchanger 20).

In preferred embodiments of the invention, NH₃ is alternatively or subsequently heated up further by absorption of heat from the flue gas in a second heat exchanger provided and interconnected for the purpose. The first heat exchanger is preferably downstream of the combustion device in flow direction of the flue gas; the streams flowing through it are firstly the hot flue gas and secondly the NH₃ to be heated further. Heat recovered from the flue gas is thus used for further heating of NH₃ (cf. FIGS. 8 and 9, heat exchanger 22).

### NH₃-Catalytic Decomposition

The inventive catalytic decomposition of NH₃ is the actual reaction for formation of H₂, which proceeds thermally in principle, but is accelerated by the use of an NH₃ decomposition catalyst. According to the invention, the catalytic decomposition of NH₃ can be conducted under various conditions using various NH₃ decomposition catalysts and with various interconnections with different reactor types.

According to the invention, the catalytic decomposition of NH₃ is preferably effected by supplying heat in the presence of an NH₃ decomposition catalyst. Important parameters for the catalytic decomposition of NH₃ are the type of NH₃ decomposition catalyst, the reaction temperature and the reaction pressure.

Useful NH₃ decomposition catalysts in accordance with the invention include various materials. The reaction temperature at which the catalytic decomposition of NH₃ proceeds is determined in particular by the choice of the NH₃ decomposition catalyst.

In preferred embodiments of the invention, a nickel-based NH₃ decomposition catalyst is used. The reaction temperature and the reaction pressure determine the equilibrium conversion. At 900° C. and a pressure of 20 bar, the decomposition of NH₃ proceeds nearly quantitatively. At 650° C., the conversion of NH₃ is about 98.5%, and at 500° C. only about 95%. Preference is given in accordance with the invention to establishing reaction temperatures in the range from about 600° C. to about 900° C., preferably about 600° C. to about 700° C., so as to achieve a high conversion. In terms of energy balance and conversion, optimal reaction temperatures range from about 630° C. to 640 °C. Nickel-based NH₃ decomposition catalysts are advantageous in spite of the comparatively high reaction temperature. Because of the high conversion, the remaining residual content of undecomposed NH₃ in the product gas is comparatively low, and so it is preferable to dispense with any separate separation of undecomposed NH₃ for recovery thereof. Instead, the combined separation of N₂ and undecomposed NH₃ from the product gas is then combined by pressure swing adsorption in the course of purification of H₂.

The NH₃ decomposition catalyst preferably comprises supported nickel. Preferred support materials are selected from the group consisting of Al₂O₃, MgO, SiO₂, mesoporous SiO₂ (e.g. MCF-17, MCM-41, SBA-15), zeolite (e.g. HY, H-ZSM-5), BaMnO₃, BaTiO₃, BaZrO₃, CaMnO₃, CaTiO₃, CaZrO₃, CeO₂, Gd₂₀₃, GdAlO₃, KNbO₃, La₂O₃, LaALO₃, MnO₂, NaNbO₃, Nb₂O₅, Sm₂₀₃, SmAlO₃, SrMnO₃, SrTiO₃, SrZrO₃, TiO₂, Y₂O₃, ZrO₂, carbon (e.g. CNTs, SWCNTs, AX-21, MSC-30, MESO-C, GNP, activated carbon, graphene, graphene oxide), attapulgite, hydrocalumite, sepiolite, and mixtures thereof.

In other preferred embodiments of the invention, a ruthenium-based NH₃ decomposition catalyst is used. For this purpose, preference is given in accordance with the invention to reaction temperatures in the range from about 450° C. to about 500° C., although somewhat lower conversions of about 95%, for example, can be achieved, such that the remaining residual content of undecomposed NH₃ in the product gas is greater.

Alternatively, it is optionally also possible to use other NH₃ decomposition catalysts at even lower reaction temperatures. The lower the reaction temperature, the lower the conversion and the more undecomposed NH₃ has to be separated from the product gas and recycled.

Preferably in accordance with the invention, the reaction pressure is about 15 bara to about 25 bara. The stoichiometry of the reaction (2 NH₃→N₂+3 H₂) increases the volume, and therefore an elevated reaction pressure fundamentally has an adverse effect on conversion. On the other hand, it is advisable to operate the entire process at higher pressures in order to limit the container volume and hence capital costs. At a reaction pressure of only 1 bar, conversions of more than 99% would be achievable at reaction temperatures above 400 °C. However, since a reaction pressure of 1 bar is useful only for the smallest systems, the system of the invention is preferably operated at a higher reaction pressure, even if a certain loss in conversion must be accepted as a result.

The reaction pressure is defined in particular by the execution of the purification of H₂. The pressure swing absorption (PSA) preferred in accordance with the invention for purification of H₂ can preferably be operated effectively in accordance with the invention at a pressure in the range of about 15 bar to about 25 bar. The pressure of the product gas on departure from the NH₃ decomposition device is preferably in the range of about 15 to about 25 bara, more preferably about 18 bara to about 22 bara, even more preferably about 19 bara to about 21 bara. In this way, a good balance is found between the requirements of pressure swing adsorption on the one hand and the conversion achieved on the other hand.

The decomposition of NH₃ can in principle proceed in different reactor types.

In an adiabatic reaction regime, the internal heat of the reaction gas is used as energy source for the reaction. Suitable reactors for this purpose are autothermal reformers and secondary reformers which work with internal energy generation. Combustion air is added to the process gas and a portion of the reaction gas is combusted in order to increase the temperature such the temperature at the reactor exit is that desired. A disadvantage is the presence of the water formed in the combustion in the process gas, which has to be removed by condensation. A portion of the undecomposed NH₃ then dissolves in the condensed water and is lost. Moreover, the high temperatures lead to formation of significant amounts of nitrogen oxides.

According to the invention, these disadvantages are avoided in that the product gas is physically separated from the combustion gas and the flue gas formed therefrom. The product gas is formed in the NH₃ decomposition device of the invention by decomposition of NH₃ and leaves the NH₃ decomposition device via a dedicated outlet. The combustion gas is combusted together with combustion air in the combustion device, and the flue gas formed leaves the combustion device likewise via a dedicated outlet, preferably into a flue gas duct. Product gas and flue gas are not mixed with one another, but remain physically separated from one another. Heat of combustion formed in the combustion of the combustion gas flows into the NH₃ decomposition device as a heat flow, hence providing the heat required for the maintenance of the endothermic decomposition of NH₃.

Preferably, the catalytic decomposition of NH₃ is performed isothermally, quasi-isothermally or in a mixed isothermal and adiabatic process regime. In an isothermal reaction regime, the temperature of the gas remains largely unchanged.

In preferred embodiments of the invention, the catalytic decomposition of NH₃ is effected in a reactor analogous to a primary reformer. For this purpose, the reactor comprises both the NH₃ decomposition device of the invention and the combustion device of the invention.

For this purpose, the NH₃ decomposition catalyst is preferably disposed in at least one tube through which NH₃ flows, more preferably at least two tubes, even more preferably at least three tubes (NH₃ decomposition device). The at least one tube contains the NH₃ decomposition catalyst. NH₃ preferably flows through the at least one tube from the top downward. In a physically separated combustion chamber, the combustion gas combusted is preferably a mixture of NH₃ and H₂ together with combustion air (combustion device). The N₂ formed in addition to H₂ in the catalytic decomposition of NH₃ is inert and serves as an additional heat carrier. The heat of combustion generated by the combustion process in the combustion chamber of the combustion device is used to heat up the NH₃ decomposition device, preferably the tube(s) through which the NH₃ to be decomposed is passed. For this purpose, a heat flow is directed from the combustion device into the NH₃ decomposition device.

In particularly preferred embodiments of the invention, NH₃ is preheated prior to entry into the NH₃ decomposition device of the invention. As a result of this preheating, the temperature of the NH₃ prior to entry into the NH₃ decomposition device of the invention is preferably at least about 600° C., preferably at least about 630 °C. The temperature of the NH₃ is preferably at most about 850° C., preferably at most about 820 °C. More preferably, the temperature of the NH₃ on entry into the NH₃ decomposition device of the invention is about 780° C. to 820° C., preferably about 800° C. In this case, the NH₃ decomposition device of the invention and the combustion device of the invention preferably form a reactor designed analogously to a primary reformer. The NH₃ decomposition catalyst is preferably nickel-based. In preferred embodiments, the reaction temperature in the NH₃ decomposition device, preferably in the at least one tube containing the NH₃ decomposition catalyst and through which the NH₃ is conducted, is preferably about 630° C. to about 670° C., preferably about 650 °C. In other preferred embodiments, this temperature is about 660° C. to 700° C., preferably about 680 °C. The product gas leaves the reactor (the NH₃ decomposition device) preferably at a pressure of about 15 bara to about 25 bara, preferably about 20 bara.

In further particularly preferred embodiments of the invention, the decomposition of NH₃ is effected in two stages in two NH₃ decomposition devices through which the flow passes successively (cf. FIG. 9). In a preliminary reactor (first NH₃ decomposition device), only a portion of the NH₃ is decomposed at first. The remaining decomposition of NH₃ up to the maximum conversion obtained is then effected in a second NH₃ decomposition device. Preferably, for this purpose, the second NH₃ decomposition device together with the combustion device of the invention forms a reactor described in detail above, of analogous design to a primary reformer.

The NH₃ is preferably preheated before being introduced into the preliminary reactor (first NH₃ decomposition device). The temperature of the NH₃ after heating and on entry into the preliminary reactor (first NH₃ decomposition device) is about 620° C. to about 680° C., preferably about 650° C. The preheated NH₃ then enters the preliminary reactor which contains NH₃ decomposition catalyst and in which some degree of catalytic decomposition of NH₃ to N₂ and H₂ takes place. An intermediate product gas is formed, which still contains considerable residual amounts of undecomposed NH₃, but also N₂ and H₂ that have already formed. As a result of the endothermic decomposition of NH₃, the intermediate product gas preferably cools down.

Preferably, the conversion of decomposed NH₃ in the preliminary reactor is at most 25%, more preferably at most 20%, of the conversion achieved overall.

Preferably, the conversion of decomposed NH₃ in the preliminary reactor is at least 10%, more preferably at least 15%, of the conversion achieved overall.

After leaving the preliminary reactor, the intermediate product gas is preferably reheated before it enters the downstream, second NH₃ decomposition device. The temperature of the intermediate product gas after reheating and on entry into the second NH₃ decomposition device is preferably about 620° C. to about 680° C., more preferably about 650 °C. In the second NH₃ decomposition device, the residual decomposition of NH₃ then proceeds up to the overall conversion achieved.

In this preferred embodiment of the invention, for the same overall conversion, the temperature of the intermediate product gas on entry into the preliminary reactor (first NH₃ decomposition device) and on entry into the second NH₃ decomposition device may each be lower than the temperature of the NH₃ in the case of single-stage decomposition of NH₃, i.e. in the case of passage through only a single NH₃ decomposition device. Because of the lower temperature, there is a lower degree of nitriding of the pipelines, which increases the service life of the steel that comes into contact with NH₃.

The NH₃ decomposition catalyst in the first NH₃ decomposition device (preliminary reactor) is preferably the same as in the second NH₃ decomposition device.

### Combustion Gas:

According to the invention, heat is provided by combustion of a combustion gas in a combustion device. For this purpose, the combustion device preferably comprises one or more burners, preferably at least two burners, more preferably at least three burners.

The combustion gas preferably contains NH₃. The combustion device of the invention is therefore preferably an NH₃ combustion device.

The combustion gas preferably contains a mixture of H₂ and NH₃, since that this mixture generates a moderate flame temperature and has better combustion properties than pure NH₃. A suitable mixing ratio of H₂ and NH₃ additionally results in formation of less nitrogen oxide than in the absence of H₂.

### Combustion Air

Preferably, the combustion device (combustion chamber of the reactor) is supplied with combustion air which is preferably preheated beforehand in at least one heat exchanger. This at least one heat exchanger is preferably within the flue gas duct, where the combustion air absorbs heat from the flue gas. This means that surplus heat in the flue gas can be utilized for preheating of the combustion air (cf. FIGS. 8 and 9, heat exchanger 43 or heat exchanger 45).

The combustion air is preferably preheated in at least two heat exchangers. These at least two heat exchangers are preferably within the flue gas duct, where the combustion air in each case absorbs heat from the flue gas. In preferred embodiments of the invention, there is a first heat exchanger in the flue gas duct downstream of the flue gas heat exchanger in flow direction of the flue gas, which preferably serves to preheat the combustion air, where the combustion air absorbs heat from the flue gas (cf. FIGS. 8 and 9, heat exchanger 43). There is preferably a second heat exchanger in the flue gas duct upstream of the flue gas heat exchanger in flow direction of the flue gas, which preferably serves to further heat the combustion air, where the combustion air again absorbs heat from the flue gas (cf. FIGS. 8 and 9, heat exchanger 45).

Preferably, the combustion air is cleaned by means of a filter before being fed into the plant, compressed to the required pressure with a compressor and then directed through and heated by means of at least one heat exchanger in the flue gas duct. The heated combustion air then flows into the combustion device. Shortly upstream of entry into the combustion device or within the combustion device, the combustion air is mixed with the combustion gas (preferably NH₃ in a mixture with H₂).

Product Gas—after Catalytic Decomposition Up to Purification of H₂

The product gas leaves the NH₃ decomposition device at high temperature. In order to utilize the heat present in the product gas, there is preferably at least one heat exchanger downstream of the NH₃ decomposition device in flow direction of the product gas, through which the product gas flows before the product gas is supplied to a purification of H₂. The product gas preferably flows through at least two heat exchangers, more preferably at least three heat exchangers, even more preferably at least four heat exchangers, before the product gas is supplied to a purification of H₂.

Preferably, the temperature of the product gas on exit from the NH₃ decomposition device is in the range of about 650±100° C., more preferably about 650±50 °C.

There is preferably a product gas heat exchanger as part of an H₂O evaporation device downstream of the NH₃ decomposition device in flow direction of the product gas. Hydrogen embrittlement can thus be avoided. The product gas heat exchanger is preferably functionally connected to a steam drum. The H₂O evaporation device thus preferably comprises the product gas heat exchanger and the steam drum. Preferably, heat present in the hot product gas leaving the NH₃ decomposition device is absorbed by water in the product gas heat exchanger and utilized to heat or to raise steam in the steam drum. The steam drum is preferably fed with demineralized water. The steam is fed into the NH₃ evaporation device via a conduit system, in which NH₃ absorbs heat from the steam and evaporates. After leaving the NH₃ evaporation device, the NH₃ is then heated further and fed to the NH₃ decomposition device.

Preferably, the temperature of the product gas on exit from the product gas heat exchanger is in the region of about 350±100° C., more preferably about 350±50 °C.

There is preferably a further heat exchanger downstream of the product gas heat exchanger (H₂O evaporation device) in flow direction of the product gas, which preferably serves to heat the NH₃ to the desired temperature on entry into the NH₃ decomposition device or an even lower intermediate temperature.

Preferably, the temperature of the product gas on exit from the product gas heat exchanger is in the region of about 150±100° C., more preferably 150±50 °C.

Since the temperature of the process gas stream is already comparatively low after the product gas has flowed through the product gas heat exchanger (H₂O evaporation device) and the further heat exchanger, it is preferable to use a preheater for water used in steam raising which is downstream of the product gas heat exchanger (H₂O evaporation device) in flow direction of the product gas and preferably also downstream of the further heat exchanger in flow direction of the product gas (cf. FIGS. 8 and 9: product gas heat exchanger 26; further heat exchanger 20; preheater 28).

Preferably, the temperature of the product gas on exit from the preheater is in the region of about 90±50° C., more preferably about 90±25 °C.

There is preferably an additional heat exchanger in flow direction of the product gas, preferably downstream of the water preheater in flow direction of the product gas, which preferably serves to heat water and brings the product gas to the desired temperature for a preferably subsequent purification of H₂ (cf. FIGS. 8 and 9, process cooler 29). Preferably in accordance with the invention, the heat absorbed by the water is used for preheating of liquid NH₃.

Preferably, the temperature of the product gas on exit from the additional heat exchanger is in the region of about 35±15° C., more preferably about 35±10 °C.

### Product Gas—Residual Amounts of Undecomposed NH₃

The recovery of NH₃ which is preferred in accordance with the invention preferably serves to separate undecomposed NH₃ from the product gas and to provide it for further utilization as combustion gas or recovered reactant.

NH₃ can be separated out by various technical means, for example membrane separation, adsorption and condensation, although these processes require high pressures and are therefore energy-intensive.

In preferred embodiments of the invention, the absorption of NH₃ in water can be conducted at process pressures. However, in order to separate the mixture of NH₃ and water by rectification, steam is required as energy carrier. Since, according to the invention, the combustion gas likewise comprises NH₃, preferably in a mixture with H₂, additional NH₃ or H₂ has to be combusted in order to raise the steam required for rectification, which leads to a reduction in the overall yield of H₂.

If steam is required not only for the heating and evaporating of NH₃ but also for additional purposes, i.e. if there is a further consumer of steam, for example an evaporator of an NH₃ scrub, it may be advantageous to extend the combination of product gas heat exchanger and flue gas heat exchanger to include a third heat exchanger in which water absorbs additional heat from the product gas or flue gas.

In other preferred embodiments of the invention, separate recovery of NH₃ is dispensed with. For this purpose, the reaction parameters are chosen so as to achieve maximum conversion, and hence the amount of undecomposed NH₃ in the product gas is kept as low as possible. However, this is barely possible solely by means of a high reaction temperature in an economically viable process regime, since the equilibrium temperature would then have to be at 900° C. or even higher. If separate recovery of NH₃ is dispensed with, given optimization of the process parameters within economically acceptable limits and correspondingly good conversion, small residual amounts of undecomposed NH₃ can be separated off by other measures. It is thus preferable in accordance with the invention to purify H₂ from the product gas by pressure swing adsorption (PSA). Preferably in accordance with the invention, small residual amounts of undecomposed NH₃ can preferably also be separated out in the pressure swing adsorption, which allows combination of the recovery of NH₃ and the purification of H₂ to a combined step.

### Product Gas—Purification of H₂ and Removal of Residual Gas Mixture

The mode of purification of H₂ in the product gas depends on the later industrial use of the H₂, which determines the requirements on quality. Technical grade H₂ can remain relatively impure and have a purity of about 99.7%, for example. By contrast, if H₂ should be intended for use in fuel cells, a distinctly higher purity in the region of about 99.96%, for example, would be necessary.

In preferred embodiments of the invention, H₂ is purified by partial condensation, for example analogously to air fractionation. However, this entails the use of a compressor in order to generate the high inlet pressures required of about 230 bar, for example. In addition, an upstream adsorptive drying operation is necessary in order to remove traces of NH₃ and H₂O. Furthermore, the separation unit itself is required, which makes this concept costly in terms of capital and operating costs.

In other preferred embodiments of the invention, H₂ is purified by membranes. However, H₂ and N₂ are separable with only moderate selectivities and yields. It is also necessary to provide a high inlet pressure for separation via membranes, which requires the use of a compressor.

More preferably in accordance with the invention, H₂ is purified by pressure swing adsorption (PSA). One reason why adsorptive separation in a pressure swing adsorption device is preferred in accordance with the invention is because it proceeds at moderate pressures and additionally also achieves high purity of H₂, >99.9% if required, with a yield of H₂ of about 85%, for example. As already mentioned, pressure swing adsorption is also capable of separating out residual amounts of NH₃ and H₂O.

For this purpose, the product gas, before entering the pressure swing adsorption device, is preferably cooled to the desired temperature with a process cooler. The corresponding amount of heat is preferably absorbed by water in the process cooler (cf. FIGS. 8 and 9, process cooler 29).

Preferably in accordance with the invention, the cooling water thus heated is preferably used for preheating of NH₃ in a preheating device in which NH₃ absorbs heat from the water (cf. FIG. 7, preheating device 70).

Subsequently, the cooled product gas is preferably sent to a pressure swing adsorption device, where the gas mixture is separated under pressure by adsorption.

### H₂—After Purification Up to Storage

The H₂ separated off preferably leaves the apparatus for purification of H₂, preferably the pressure swing adsorption device, and is preferably brought to an elevated pressure with an H₂ compressor. The compressed H₂ then preferably flows through a heat exchanger in which cooling water absorbs heat from the compressed H₂ (cf. FIGS. 8 and 9, compressor 33 and heat exchanger 34).

In preferred embodiments of the invention, the H₂ separated off is then brought to a further-elevated pressure with a second H₂ compressor. Preferably, the further-compressed H₂ then flows through a second heat exchanger in which cooling water likewise absorbs heat from the compressed H₂ (cf. FIGS. 8 and 9, compressor 35 and heat exchanger 36).

Preferably in accordance with the invention, the cooling water thus heated is preferably used for preheating of NH₃ in a preheating device in which NH₃ absorbs heat from the water (cf. FIG. 7, preheating device 70).

Subsequently, the compressed H₂ is discharged from the plant at a pressure of about 70 bar, for example, and, for example, stored in a suitable pressure vessel or sent directly to a further use.

### Residual Gas Mixture

The residual gas mixture that remains after the purification/removal of H₂, preferably in the pressure swing adsorption device, typically contains N₂, H₂O, residual NH₃, and H₂.

Preferably, the residual gas mixture is sent to the combustion device so that it can be used for the generation of heat of combustion.

### Flue Gas

The flue gas leaves the combustion device at high temperature and preferably enters a flue gas duct. In order to utilize the heat present in the flue gas, there is preferably at least one heat exchanger downstream of the combustion device in flow direction of the flue gas, through which the flue gas flows before the flue gas is discharged to the environment, for example via a chimney. The flue gas preferably flows through at least two heat exchangers, more preferably at least three heat exchangers, even more preferably at least four heat exchangers, before the flue gas is released to the environment.

In preferred embodiments, the temperature of the flue gas on exit from the combustion device is in the region of about 850±100° C., more preferably about 850±50 °C.

In other preferred embodiments, the temperature of the flue gas on exit from the combustion device is in the region of about 880±100° C., more preferably about 880±50 °C.

There is preferably firstly a first heat exchanger in the flue gas duct downstream of the combustion device in flow direction of the flue gas, which is preferably used for heating of the

NH₃ to the desired temperature on entry into the NH₃ decomposition device.

The temperature of the flue gas on exit from the first heat exchanger is preferably in the region of about 700±100° C., more preferably about 700±50 °C.

There is preferably a second heat exchanger downstream of the first heat exchanger in flow direction of the flue gas, which preferably serves to heat the combustion air.

The temperature of the flue gas on exit from the second heat exchanger is preferably in the region of about 300=100° C., more preferably about 300±50 °C.

Since the temperature of the flue gas stream is already comparatively low after the flue gas has flowed through the first heat exchanger and the second heat exchanger, it is advantageous to use a flue gas heat exchanger for water used in steam raising which is downstream of the first heat exchanger in flow direction of the flue gas and preferably also downstream of the second heat exchanger in flow direction of the flue gas (cf. FIGS. 8 and 9: first heat exchanger: heat exchanger 22; second heat exchanger: heat exchanger 45; flue gas heat exchanger 52).

The flue gas heat exchanger preferably contributes at least some of the heat for the raising of steam.

Preferably, the temperature of the flue gas on exit from the flue gas heat exchanger is in the region of about 250±100° C., more preferably about 250±50 °C.

There is preferably an additional heat exchanger in flow direction of the flue gas, preferably downstream of the flue gas heat exchanger in flow direction of the flue gas, which preferably serves to heat combustion air (cf. FIGS. 8 and 9, heat exchanger 43).

The temperature of the flue gas on exit from the additional heat exchanger is preferably in the region of about 150±100° C., more preferably about 150±50 °C.

In preferred embodiments of the invention, when the catalytic decomposition of the NH₃ takes place in two stages in a first NH₃ decomposition device and a second NH₃ decomposition device, there is preferably a further heat exchanger downstream of the first heat exchanger in flow direction of the flue gas and preferably downstream of the second heat exchanger in flow direction of the flue gas, which is preferably used for heating of the intermediate product gas after it leaves the first NH₃ decomposition device (preliminary reactor) and before it enters the second NH₃ decomposition device (together with combustion device analogous to a primary reformer) (cf. FIG. 9, further heat exchanger 67).

The temperature of the flue gas on exit from the further heat exchanger is preferably in the region of about 450±100° C., more preferably about 450±50 °C.

### Water/Steam

After the catalytic decomposition of the NH₃ and the evaporation of the NH₃, the flue gas leaving the combustion device constitutes the largest energy sink in the process. Energy recovery from the flue gas is limited in that temperature differentials of less than about 45 K between the flue gas and the other process-side streams (reactant for catalytic decomposition, combustion gas, combustion air, water for the raising of steam) would require uneconomically large heat exchangers. Therefore, even after all economically viable steps in the process-side heat integration, there remains a certain temperature differential between the flue gas and the dew point of the water present in the flue gas.

Preferably in accordance with the invention, this remaining temperature differential is preferably utilized to produce heated cooling water, with which NH₃ is then preheated.

For the preheating and subsequent evaporation of NH₃, preference is given in accordance with the invention in particular to the following five configurations:
1. with heat from steam and steam condensate, preferably in countercurrent;
2. additionally with heat from blowdown and from unevaporated surplus boiler feed water;
3. additionally with heat from cooling water, but without utilization of heat from the flue gas and without utilization of heat from the H₂ compression, where preheating is limited by the available heat discharged from the process stream and utilized for heating of cooling water;
4 additionally with heat from the H₂ compression and from the steam condensate from the NH₃ evaporation, for production of liquid heated cooling water at relatively high temperature or of liquid heated cooling water at relatively low temperature; more heat is available in the heated cooling water than can be utilized in the process, and so the preheating of the NH₃ is limited by the minimum temperature differential between the cooling water and NH₃; and/or
5. additionally with heat from the flue gas, but without utilization of heat from the H₂ compression, for production of liquid heated cooling water at relatively high temperature or of liquid heated cooling water at relatively low temperature; more heat is likewise available in the heated cooling water than can be utilized in the process, and so the preheating of the NH₃ is limited by the minimum temperature differential between the cooling water and NH₃.

Water fed into the plant for the raising of steam is preferably demineralized.

The water is preferably preheated by means of a preheater through which product gas flows and in which the water absorbs heat from the product gas (cf. FIGS. 8 and 9, preheater 28). In flow direction of the product gas, the preheater is preferably downstream of the product gas heat exchanger.

The water after leaving the preheater is preferably at a temperature of at least 100° C., more preferably at least 110° C., even more preferably at least 115 °C.

Preferably, the temperature of the water thereafter does not drop again below that temperature of at least 100° C., preferably at least 110° C., even more preferably at least 120° C., before the water in the NH₃ evaporation device of the invention releases heat to NH₃ for evaporation thereof.

Air and other gases dissolved in the water are preferably removed in a degasser.

The water is preferably then directed through the flue gas heat exchanger and heated. The flue gas heat exchanger cools the flue gases from the combustion device in the flue gas duct, with utilization of heat present in the flue gas to heat the steam.

The water after leaving the flue gas heat exchanger is preferably at a temperature of at least 180° C., more preferably at least 200° C., even more preferably at least 220 °C.

Preferably, the temperature of the water thereafter does not drop again below that temperature of at least 180° C., preferably at least 200° C., even more preferably at least 220° C., before the water in the NH₃ evaporation device of the invention releases heat to NH₃ for evaporation thereof.

A person skilled in the art will recognize that the water may be in liquid form, in gaseous form (i.e. as steam) or in the form of a biphasic system, depending on the temperature and prevailing pressure conditions.

The steam is then preferably directed into a steam drum (cf. FIGS. 1-9, steam drum 60).

From the steam drum, the water is preferably directed through the product gas heat exchanger and hence absorbs further heat in order then preferably to be returned to the steam drum.

The product gas heat exchanger is downstream of the NH₃ decomposition device in flow direction of the product gas and serves to cool the product gas after it leaves the NH₃ decomposition device, likewise with utilization of heat present in the product gas to heat the steam.

The hot steam preferably leaves the steam drum and is preferably introduced into the NH₃ evaporation device. The condensation of the steam generates heat in order to evaporate the preheated NH₃. After flowing through the NH₃ evaporation device, the steam condensate is preferably sent to the preheater which serves to preheat the NH₃, and so the heat present in the steam is used for the heating of the NH₃ in two stages. Once it has flowed through the preheater, the steam condensate can be discharged from the plant.

The raising of steam produces a liquid stream at boiling temperature, called the “blow-down”. The “blowdown” is preferably added to the condensed steam after it leaves the NH₃ evaporation device and before it enters the preheater (FIG. 5).

Since heat is available from the process, it is preferable to recover this heat by generating more than the amount of boiler feed water required, and separating off this amount before it enters the H₂O evaporation device and adding it to the “blowdown”. For this purpose, the steam leaving the flue gas heat exchanger is preferably divided into two substreams. A first substream is preferably introduced into the steam drum. A second substream preferably bypasses the steam drum via a bypass and is added to the blowdown (FIG. 6).

In addition to the above-described stream of water or steam, preferably in accordance with the invention, further water streams are involved as well.

Such a water stream which is preferred in accordance with the invention comprises cooling water, which is preferably taken from a process cooler upstream of an apparatus for purification of H₂ in flow direction of the product gas, preferably a pressure swing adsorption device where it has absorbed heat beforehand from the product gas (heated cooling water), or from a heat exchanger of a possible H₂ compressor where it has absorbed heat beforehand from compressed H₂ (heated cooling water).

A further such water stream which is preferred in accordance with the invention comprises water, which is preferably circulated in a circuit and which has absorbed heat beforehand from the flue gas, for which there is preferably an additional heat exchanger functionally connected to a further heat exchanger, where these are preferably connected to one another via a ring conduit through which the water is circulated, preferably with a pump.

### DESCRIPTION OF THE FIGURES

The present invention is elucidated in detail below by working examples with reference to the drawings. FIGS. 1 to 16 respectively show, in the form of flow diagrams, preferred embodiments of the plants of the invention in which preferred embodiments of the method of the invention can be performed. FIGS. 4, 7, 10 and 12-16 each show only a portion of embodiments of the invention, which are preferred as preferred developments of all other figures of embodiments of the invention.

A first illustrative flow diagram of a plant of the invention is elucidated hereinafter with reference to FIG. 1. Liquid NH₃ is directed from tank 10 into NH₃ evaporation device 14 and evaporated therein. The required heat is obtained by condensation of steam (see below). From the NH₃ evaporation device 14, the evaporated NH₃ flows into NH₃ decomposition device 24, where the endothermic decomposition of NH₃ to N₂ and H₂ is catalyzed. The heat required to maintain the reaction is generated as heat of combustion by burning combustion gas (e.g. NH₃/H₂/air or CH₄/air) and introduced as a heat flow from the combustion device 18 into the NH₃ decomposition device 24. The flue gas obtained in the combustion flows through flue gas heat exchanger 52, with release of the heat present in the flue gas is released to water, which affords steam. The steam, after passing through flue gas heat exchanger 52, is introduced into steam drum 60 and then via conduit 63 into NH₃ evaporation device 14. The heat released in the condensation of the steam in NH₃ evaporation device 14 evaporates the NH₃ (see above).

FIG. 2 illustrates an inventive variant of the embodiment according to FIG. 1, where the main difference is that the heat utilized for heating of water and for heating of steam is not the heat in the flue gas but the heat in the product gas. The product gas obtained in the catalytic decomposition flows through product gas heat exchanger 26, with release of the heat present in the product to water, which affords steam. The steam, after passing through product gas heat exchanger 26, is introduced into steam drum 60 and then via conduit 63 into NH₃ evaporation device 14.

FIG. 3 illustrates a variant of the invention in which both flue gas heat exchanger 52 and product gas heat exchanger 26 are utilized for heating of water or steam. Steam is directed into steam drum 60 from flue gas heat exchanger 52 and from product gas heat exchanger 26. The steam is then introduced via conduit 63 into NH₃ evaporation device 14.

FIG. 4 illustrates, as a detail, a variant of the invention in which liquid NH₃ is directed from tank 10 firstly into preheater 13 and preheated therein by absorption of heat from heated water, before the preheated NH₃ is fed to the NH₃ evaporation device 14. The heated water used here is fed to the preheater 13 as steam condensate via conduit 64 from the NH₃ evaporation device 14. In this way, the heat present in the steam is used in two stages for the heating and subsequent evaporation of NH₃. After passing through the preheater 13, the steam condensate can, for example, be discharged from the plant.

FIG. 5 illustrates a variant of the invention that also includes occurrence of a liquid stream as blowdown in the raising of steam at boiling temperature. In this preferred embodiment, the blowdown is added to the condensed steam after it leaves the NH₃ evaporation device 14 and before it enters the preheater 13. In the example shown, the blowdown is fed into conduit 64 via blowdown conduit 68 from steam drum 60.

FIG. 6 illustrates a variant of the invention in which the heat released in the formation of the blowdown is recovered. In the flue gas heat exchanger 52, more water is heated or more steam is raised than is required for the steam drum 60. The steam leaving the flue gas heat exchanger 52 is then divided into two substreams. A first substream is introduced into steam drum 60. A second substream bypasses steam drum 60 via bypass 69 and is fed into blowdown conduit 68.

FIG. 7 illustrates, as a detail, a variant of the invention in which the yield of H₂ is increased by reducing the amount of steam produced and instead reintegrating residual heat remaining in the process. This ultimately requires less fuel that preferably contains H₂. In the variant illustrated in FIG. 7, the energy gap in the preheating and evaporation of NH₃ is closed by a cooling water-fed preheating device 70. Water for cooling may be required in various places in the plant, for example in process cooler 29 upstream of an apparatus for purification of H₂ in flow direction of the product gas, preferably a pressure swing adsorption device 31, or in heat exchangers 34 or 36 of any H₂ compressors 33 or 35. The water absorbs process heat and is thus heated. The heat absorbed can be utilized for preheating of liquid NH₃.

FIG. 8 illustrates a further variant of the invention, which is more complex and in which several further plants are integrated. Liquid NH₃ at low temperature and elevated pressure is directed from tank 10 via conduit 11 by means of pump 12 through preheater 13 and heated, and evaporated in NH₃ evaporation device 14, then flows via conduit 15 to branch 16, where the NH₃ stream is divided into two substreams. Proceeding from branch 16, a first substream of the NH₃ is fed via conduit 17 to combustion device 18. A second substream of the NH₃ is conducted from branch 16 via conduit 19 through heat exchanger 20 and then flows via conduit 21 through heat exchanger 22 where the NH₃ is heated further and then flows via conduit 23 into NH₃ decomposition device 24 which includes the NH₃ decomposition catalyst, and so that the catalytic decomposition of NH₃ takes place therein. The stream preferably flows through the NH₃ decomposition device 24 from the top downward. The heat required for maintenance of the reaction is generated in that the NH₃ decomposition device 24 is heated up by combustion of NH₃ in combustion device 18.

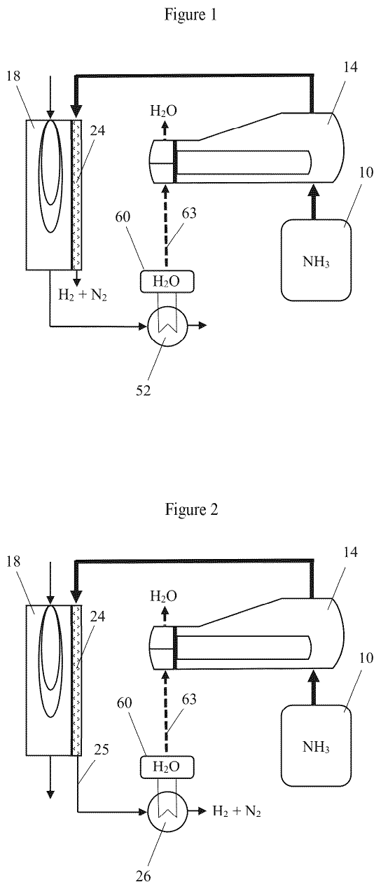

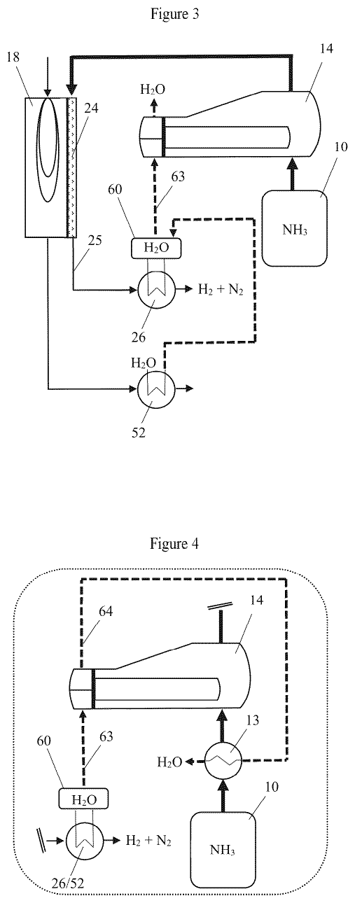

After the decomposition of NH₃, the product gas formed (comprising N₂, H₂, H₂O and any residual NH₃) flows through product gas heat exchanger 26, then heat exchanger 20 in crossflow, then conduit 27 and, for further cooling, a further heat exchanger and preheater 28 operated with water, for example. Finally, the product gas is cooled further by a process cooler 29 and then fed via conduit 30 to a device for purification of H₂, preferably a pressure swing adsorption device 31, where the gas mixture is separated under pressure by adsorption. The H₂ separated off here leaves the apparatus for purification of H₂, preferably the pressure swing adsorption device 31, via conduit 32, is brought to an elevated pressure by means of a first H₂ compressor 33, flows through a heat exchanger 34, a second H₂ compressor 35 to increase the pressure further and a second heat exchanger 36, and is discharged from the plant via conduit 37 at a pressure of, for example, about 70 bar.

The residual gas mixture remaining in the apparatus for purification of H₂, preferably the pressure swing adsorption device 31, after the H₂ has been separated off contains N₂, H₂O, residual NH₃ and H₂, and is returned via return conduit 38 and fed via branching conduit 39 to the combustion device 18, such that energy present in the residual gas mixture can be utilized for the generation of heat of combustion.

Combustion air for the combustion process in the combustion device 18 is cleaned by means of filter 40, compressed by compressor 41, directed via conduit 42 through heat exchanger 43 and heated, then flows via conduit 44 and through heat exchanger 45, is heated therein and then flows via conduit 46 and the two branching branch conduits 47 and 48 into combustion device 18 where the combustion air is supplied to the substream of the NH₃ fed in via conduit 17 in order to combust it and thus generate heat of combustion.

The hot flue gas from the combustion in combustion device 18 is first cooled via heat exchanger 22, which affords heat for the heating of the NH₃ supplied to the NH₃ decomposition device 24. The flue gas is then directed further through flue gas duct 49 via heat exchanger 45, by means of which the combustion air is preheated, and then flows through flue gas denoxing unit 50, by means of which the flue gas is freed of nitrogen oxides (NOx). Subsequently, the flue gas flows via conduit 51 through flue gas heat exchanger 52, by means of which heat is recovered for heating of water, and then flows through heat exchanger 43, which likewise serves to heat up the combustion air. The flue gas is then compressed in the end region of flue gas duct 49 by means of flue gas compressor 53 and leaves the plant via chimney 54.

Water for the raising of steam is fed in via conduit 55, directed through preheater 28 and then fed at elevated temperature into degasser 56 in which air and other gases dissolved in the water are removed. By means of pump 57, the water is fed via conduit 58 through flue gas heat exchanger 52 and heated. The flue gas heat exchanger 52 serves to cool the flue gases from the combustion device 18 in the flue gas duct 49, wherein the heat energy present in the flue gas is used to heat the steam, which, after passing through the flue gas heat exchanger 52, is then directed via conduit 59 into steam drum 60. From steam drum 60, water can be directed via conduit 61 through product gas heat exchanger 26 and hence absorb further heat energy, in order then to be returned to the steam drum via conduit 62. Product gas heat exchanger 26 is positioned in exit conduit 25 downstream of the NH₃ decomposition device 24 in flow direction of the product gas and serves to cool the product gas after it leaves the NH₃ decomposition device 24. The heat obtained can thus be used to raise further steam.

The hot steam generated in steam drum 60 is introduced via conduit 63 into the upper region of the NH₃ evaporation device 14. The condensation of the steam affords the heat for evaporation of the preheated NH₃. After flowing through the NH₃ evaporation device 14, the steam condensate is fed via conduit 64 to the preheater 13, which serves to preheat the NH₃, such that the heat present in the steam is utilized in two stages for the heating of the NH₃. Once it has flowed through preheater 13, the steam condensate can be discharged from the plant.

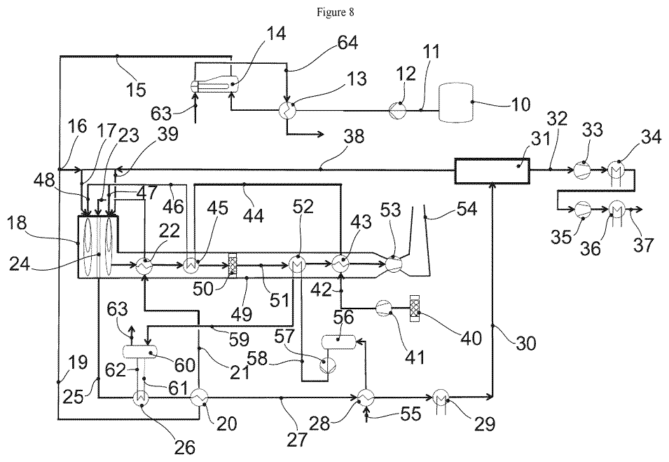

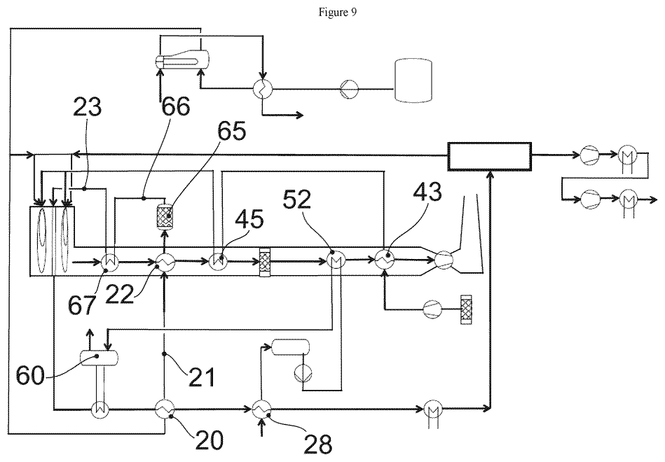

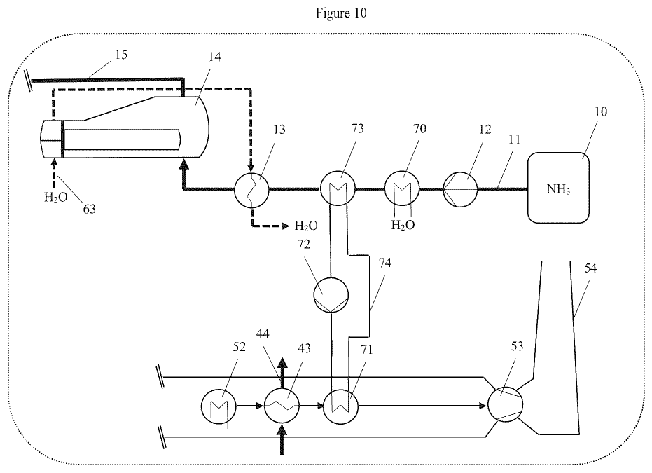

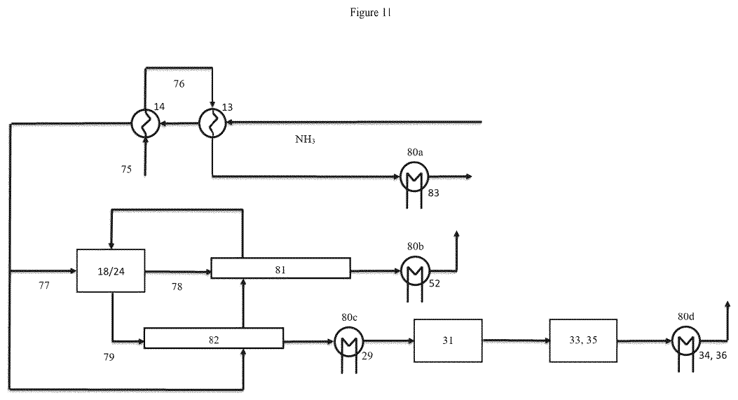

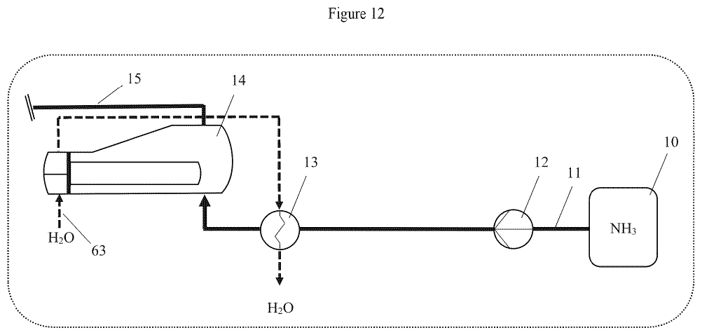

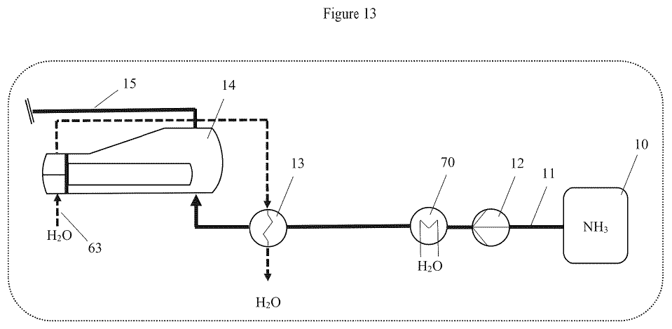

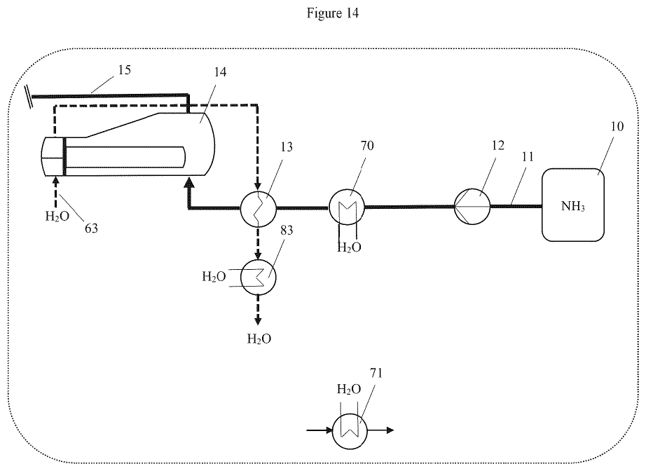

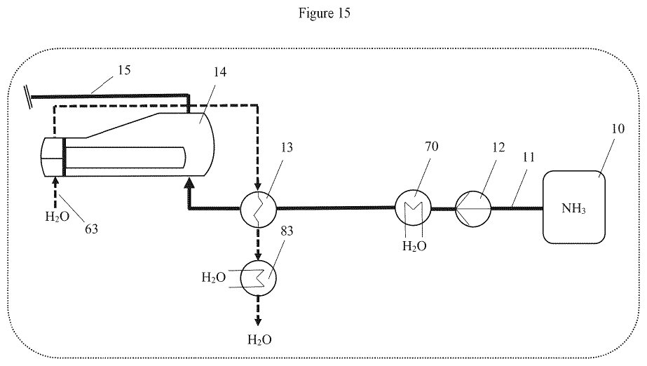

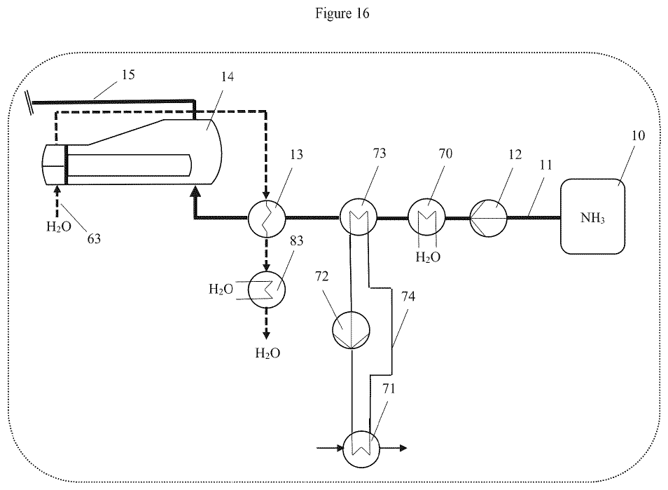

FIG. 9 likewise illustrates a further variant of the invention, which is more complex and in which several further plants are integrated. Some parts of the plant correspond to those in FIG. 8 and are therefore not elucidated in detail again. Heating and evaporation of the NH₃ are largely unchanged, as are the parts of the plant and process steps downstream of the apparatus for purification of H₂, preferably the pressure swing adsorption, after the H₂ has been separated off. In contrast to the variant in FIG. 8, there are a total of five heat exchangers in flue gas duct 49. Here, too, conduit 21 for the heating of the NH₃ leads from heat exchanger 20 to the heat exchanger 22 positioned in flue gas duct 49. However, after flowing through heat exchanger 22, the NH₃ is directed through preliminary reactor 65, with cooling of the NH₃. The gas mixture leaving the preliminary reactor 65 is then conducted via conduit 66 to heat exchanger 67, which is positioned in flue gas duct 49 upstream of heat exchanger 22 in flow direction of the flue gas. The gas mixture is heated up therein and then introduced via conduit 23 into the NH₃ decomposition device 24. The combustion air for the combustion device 18 is heated up analogously to FIG. 8, first by heating via heat exchanger 43 and then by further heating via heat exchanger 45, with both heat exchangers 43 and 45 positioned in flue gas duct 49. The water supplied for steam drum 60 is heated and evaporated via preheater 28 and flue gas heat exchanger 52 positioned in flue gas duct 49, analogously to FIG. 8. In the variant according to FIG. 9, five heat exchangers 67, 22, 45, 52 and 43 are thus in successive arrangement in flow direction of the flue gas in flue gas duct 49.

A difference in the reaction regime according to FIG. 9 compared to FIG. 8 is that the preheating of the NH₃ is limited to lower temperatures, which prolongs the service life of the steel from which the NH₃ decomposition device 24 is manufactured, even in contact with NH₃. For this purpose, the incoming gas stream is first preheated and then a portion of the catalytic decomposition is conducted in preliminary reactor 65. Subsequently, the gas mixture leaving preliminary reactor 65 is reheated and directed into NH₃ decomposition device 24, where the rest of the catalytic decomposition takes place.

FIG. 10 illustrates, as a detail, a variant of the invention in which a further heat flow from the plant is integrated into the preheating of NH₃. Without further measures, the flue gas from the combustion device 18, for example in the case of a process regime according to FIGS. 8 and 9, still leaves the flue gas duct 49 at elevated temperature because a relatively high temperature differential is required for the preheating of the combustion air. In the variant of the invention illustrated in FIG. 10, this heat in the flue gas is utilized in that it is absorbed by further water as heat transfer medium. For this purpose, a further heat exchanger 71 is mounted in the flue gas duct 49, through which water circulates as heat transfer medium, driven by pump 72. The water is heated up in the further heat exchanger 71 and can then serve, in additional heat exchanger 73, in turn, as heat source for NH₃ that has advantageously been preheated beforehand by the cooling water in the cooling water-fed preheating device 70.

FIG. 11 illustrates a schematic of possible sources of heated cooling water 80a to 80d, which can be used for preheating and optionally evaporation of NH₃. It is possible in accordance with the invention to utilize only one of these sources for heated cooling water 80a to 80d, or it is possible to utilize two or more or all these sources for heated cooling water 80a to 80d, for preheating and optionally evaporating of NH₃ (embodiments (a) to (d) and any combinations thereof). Liquid NH₃ enters preheater 13 and absorbs heat from steam condensate 76. Subsequently, the preheated NH₃ enters the NH₃ evaporation device 14 and absorbs heat from the steam 75, which in turn condenses to give steam condensate 76. (a) Positioned downstream of the preheater 13 in flow direction of the steam condensate 76 is a steam condensate heat exchanger 83 in which cooling water 80a absorbs heat from the steam condensate 76. The evaporated NH₃ leaves the NH₃ evaporation device 14 and is divided into two substreams. The combustion device 18 and the NH₃ decomposition device 24 exchange heat with one another. A first substream of the evaporated NH₃ is combusted as combustion gas in the combustion device 18 and leaves it as flue gas 78, from which heat is subsequently recovered in a flue gas heat integration 81 and reintegrated into the process. (b) Positioned downstream of the flue gas heat integration 81 in flow direction of the flue gas is a flue gas heat exchanger 52 in which cooling water 80b absorbs heat from flue gas 78. A second substream of the evaporated NH₃ is decomposed in the NH₃ decomposition device 24 to product gas 79. In order to be heated to the required temperature, this second substream of the evaporated NH₃ is first heated in a product gas heat integration 82 and then in the flue gas heat integration 81. The hot NH₃ then enters the NH₃ decomposition device 24. After leaving the NH₃ decomposition device 24, heat is recovered from product gas 79 in product gas heat integration 82 and reintegrated into the process. (c) Positioned downstream of product gas heat integration 82 in flow direction of the product gas is a process cooler 29 in which cooling water 80c absorbs heat from product gas 78. The product gas leaving the process cooler 29 is then supplied to an apparatus for purification of H₂, preferably a pressure swing adsorption device 31, and the hydrogen separated off is compressed in one or more H₂ compressors 33, 35. (d) Positioned downstream of the one or more H₂ compressors 33, 35 in flow direction of the hydrogen are one or more heat exchangers 34, 36 in which cooling water 80d absorbs heat from the hydrogen 78.

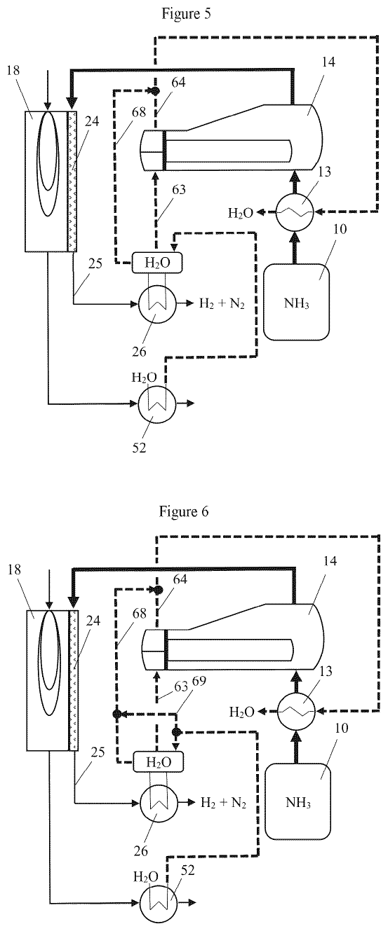

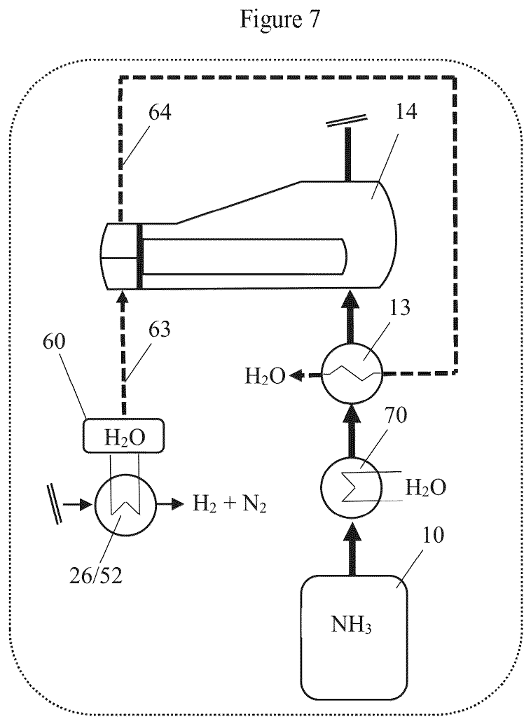

FIGS. 12 to 16 are associated with one another and additionally associated with FIGS. 4 to 7, which respectively concern the preheating of NH₃ in preheater 13 and the subsequent evaporation of NH₃ in NH₃ evaporation device 14. FIGS. 12 to 16 illustrate details of variants of the invention. In all of these variants, blowdown and boiler feed water (both not shown) are preferably combined with the steam condensate after the steam condensate has left the NH₃ evaporation device and before it has been returned to preheater 13.

FIG. 12 illustrates a comparatively simple variant in which liquid NH₃ is directed from tank 10 firstly into preheater 13 and preheated therein by absorption of heat from heated water, before the preheated NH₃ is fed to the NH₃ evaporation device 14. The heated water used here is fed to the preheater 13 as steam condensate via conduit 64 from the NH₃ evaporation device 14. In this way, the heat present in the steam is used in two stages for the heating and subsequent evaporation of NH₃. After passing through the preheater 13, the steam condensate can, for example, be discharged from the plant.

FIG. 13 illustrates a development of the variant according to FIG. 12, wherein a preheating device 70 is positioned downstream of compressor 12 and upstream of preheater 13 in flow direction of the NH₃. In preheating device 70, NH₃ is preheated by absorption of heat from heated water, before the preheated NH₃ is fed to preheater 13. The heated water may come from different sources, preferably from one of the sources 80a to 80d for heated cooling water that are elucidated above in association with FIG. 11, i.e. preferably (a) from a steam condensate heat exchanger 83, (b) from a flue gas heat exchanger 52, (c) from a process cooler 29, or (d) from a heat exchanger 34 and/or 36.

FIG. 14 illustrates another development of the variant according to FIG. 12, wherein there is positioned, downstream of the compressor 12 and upstream of the preheater 13 in flow direction of the NH₃, an additional heat exchanger 73 which is in turn preferably functionally connected to a further heat exchanger 71 in the flue gas duct. In the additional heat exchanger 73, NH₃ is preheated by absorption of heat from heated water, before the preheated NH₃ is fed to preheater 13. The heated water preferably comes from the further heat exchanger 71 in which water absorbs heat from the flue gas in the flue gas duct. Additionally positioned downstream of the preheater 13 in flow direction of the steam condensate is a steam condensate heat exchanger 83 in which cooling water absorbs heat from the steam condensate.

FIG. 15 illustrates a development of the variant according to FIG. 13 in which there is likewise positioned, downstream of the preheater 13 in flow direction of the steam condensate, a steam condensate heat exchanger 83 in which cooling water absorbs heat from the steam condensate.

Finally, FIG. 16 illustrates a combination of all variants according to FIGS. 12 to 15.

### LIST OF REFERENCE SYMBOLS

10 tank
11 conduit
12 pump
13 preheater
14 NH₃ evaporation device
15 conduit
16 branch
17 conduit
18 combustion device
19 conduit
20 heat exchanger
21 conduit
22 heat exchanger
23 conduit
24 NH₃ decomposition device
25 exit conduit
26 product gas heat exchanger
27 conduit
28 preheater
29 process cooler
30 conduit
31 apparatus for purification of H₂, preferably pressure swing adsorption device
32 conduit
33 H₂ compressor
34 heat exchanger
35 H₂ compressor
36 heat exchanger
37 output conduit for hydrogen
38 return conduit
39 branching conduit
40 filters for combustion air
41 compressor
42 conduit
43 heat exchanger
44 conduit
45 heat exchanger
46 conduit
47 branch conduit
48 branch conduit
49 flue gas duct
50 flue gas denoxing unit
51 conduit
52 flue gas heat exchanger
53 flue gas compressor
54 chimney
55 conduit for feeding in water
56 degasser
57 pump
58 conduit
59 conduit
60 steam drum
61 conduit
62 conduit
63 conduit
64 conduit
65 preliminary reactor
66 conduit
67 additional heat exchanger
68 blowdown conduit
69 bypass
70 preheating device
71 additional heat exchanger
72 pump
73 additional heat exchanger
74 ring conduit
75 steam
76 steam condensate
77 combustion gas
78 flue gas
79 product gas
80a-d cooling water
81 flue gas heat integration
82 product gas heat integration
83 steam condensate heat exchanger

### WORKING EXAMPLES

The working examples that follow serve to elucidate the invention, but should not be interpreted in a restrictive manner.

For different process regimes according to the variants illustrated in FIGS. 12 to 16, heat flows and temperatures were simulated for a model system. The results are summarized in the following table:

| Example | | | | |
|---|---|---|---|---|
| 1 | 2 | 3 | 4 | 5 |
| Figure | | | | |
| 12 | 13 | 14 | 15 | 16 |

Compressor 12:

| | | | | | | | | | | |
|---|---|---|---|---|---|---|---|---|---|---|
| T(NH₃) downstream | −34 | °C | −34 | °C | −34 | °C | −34 | °C | −34 | °C |

Preheating device 70:

| | | | | | | | | | |
|---|---|---|---|---|---|---|---|---|---|
| T(NH₃) upstream | — | −34 | °C | −34 | °C | −34 | °C | −34 | °C |
| T(NH₃) downstream | — | −5 | °C | 39 | °C | 27 | °C | 27 | °C |
| Power | — | 63 | kW | 166 | kW | 136 | kW | 136 | kW |
| T(H₂O) in | — | 44 | °C | 44 | °C | 32 | °C | 32 | °C |
| T(H₂O) out | — | 32 | °C | 32 | °C | 20 | °C | 20 | °C |

Additional heat exchanger 73:

| | | | | | | |
|---|---|---|---|---|---|---|
| T(NH₃) upstream | — | — | — | — | 27 | °C |
| T(NH₃) downstream | — | — | — | — | 62.4 | °C |
| Power | — | — | — | — | 101 | kW |
| T(H₂O) in | — | — | — | — | 90 | °C |
| T(H₂O) out | — | — | — | — | 40 | °C |

in exchange with further heat exchanger 71 in flue gas duct

| | | | | | | | |
|---|---|---|---|---|---|---|---|
| T(flue gas) upstream | — | — | 143 | °C | — | 156 | °C |
| T(flue gas) downstream | — | — | 88 | °C | — | 86 | °C |
| Power | — | — | 79 | kW | — | 101 | kW |
| T(H₂O) in | — | — | 32 | °C | — | 40 | °C |
| T(H₂O) out | — | — | 44 | °C | — | 90 | °C |

Preheater 13:

| T(NH₃) upstream | −34 | °C | −5 | °C | 39 | °C | 27 | °C | 62.4 | °C |
|---|---|---|---|---|---|---|---|---|---|---|
| T(NH₃) downstream | 62.4 | °C | 62.4 | °C | 62.4 | °C | 62.4 | °C | 62.4 | °C |
| Power | 300 | kW | 274 | kW | 219 | kW | 239 | kW | 152 | kW |
| NH₃ steam content downstream | 13% | | 21% | | 31% | | 31% | | 34% | |
| T(H₂O) downstream | 30 | °C | 30 | °C | 49 | °C | 37 | °C | 105 | °C |

NH₃ evaporation device 14:

| | | | | | | | | | | |
|---|---|---|---|---|---|---|---|---|---|---|
| T(H₂O vapor) upstream | 239.8 | °C | 239.8 | °C | 239.8 | °C | 239.8 | °C | 239.8 | °C |
| T(NH₃) upstream | 62.4 | °C | 62.4 | °C | 62.4 | °C | 62.4 | °C | 62.4 | °C |
| T(NH₃) downstream | 62.4 | °C | 62.4 | °C | 62.4 | °C | 62.4 | °C | 62.4 | °C |
| Power | 409 | kW | 372 | kW | 239 | kW | 334 | kW | 320 | kW |

Steam condensate heat exchanger 83:

| | | | | | | | | |
|---|---|---|---|---|---|---|---|---|
| T(H₂O condensate) upstream | — | — | 49 | °C | 37 | °C | 105 | °C |
| T(H₂O condensate) downstream | — | — | 30 | °C | 30 | °C | 30 | °C |
| Power | — | — | 14 | kW | 8 | kW | 84 | kW |
| T(H₂O) in | — | — | 32 | °C | 20 | °C | 20 | °C |
| T(H₂O) out | — | — | 44 | °C | 32 | °C | 32 | °C |

Cooling water power:

| | | | | | | | | | | |
|---|---|---|---|---|---|---|---|---|---|---|
| Product gas | 0 | kW | 63 | kW | 86 | kW | 82 | kW | 89 | kW |
| Steam condensate | 0 | kW | 0 | kW | 14 | kW | 8 | kW | 84 | kW |
| Flue gas | 0 | kW | 0 | kW | 79 | kW | 0 | kW | 0 | kW |
| H₂ compressor | 0 | kW | 0 | kW | 0 | kW | 74 | kW | 74 | kW |

Total

In examples 4 and 5, heat from the cooling water from the H₂ compressor is transferred to the ammonia in cooling water preheater 70.

1-36. (canceled)

37. A plant for producing H₂ by catalytic decomposition of NH₃, comprising:
a combustion device for combustion of a combustion gas, generating heat of combustion and flue gas;
an NH₃ evaporation device for evaporation of liquid NH₃ by absorption of heat from heated water;
downstream of the NH₃ evaporation device in flow direction of the NH₃, an NH₃ decomposition device for catalytic decomposition of evaporated NH₃, with absorption of heat of combustion generated in the combustion device and production of a product gas comprising H₂ and N₂;
downstream of the combustion device in flow direction of the flue gas, a flue gas heat exchanger for heating water by absorption of heat from the flue gas; and/or, downstream of the NH₃ decomposition device in flow direction of the product gas, a product gas heat exchanger for heating water by absorption of heat from the product gas; and
a conduit for the heated water from the flue gas heat exchanger and/or from the product gas heat exchanger to the NH₃ evaporation device.

38. The plant as claimed in claim 37, wherein the plant is designed for a throughput based on H₂ of at least 500 mol·h⁻¹ and the plant comprises a tank for liquid NH₃ that has a volume of at least 50 m³.

39. The plant as claimed in claim 37, wherein the NH₃ decomposition device comprises at least three catalyst beds, each of which comprises NH₃ decomposition catalyst, and wherein the combustion device comprises at least three burners for combustion of the combustion gas.

40. The plant as claimed in claim 37, wherein the NH₃ decomposition device comprises at least one catalyst bed which comprises NH₃ decomposition catalyst, wherein the length of the catalyst bed in flow direction for NH₃ is at least 1.0 m.

41. The plant as claimed in claim 37, wherein the flue gas heat exchanger and/or the product gas heat exchanger is a tube heat exchanger or shell and tube heat exchanger.

42. The plant as claimed in claim 37, wherein the plant comprises, upstream of the NH₃ evaporation device in flow direction of the NH₃, a preheater for heating NH₃ by absorption of heat from water which exits from the NH₃ evaporation device.

43. The plant as claimed in claim 37, wherein the plant comprises an apparatus for purification of H₂ including a pressure swing adsorption device.

44. The plant as claimed in claim 37, wherein the plant comprises, upstream of the NH₃ evaporation device in flow direction of the NH₃, and upstream of any preheater, a preheating device for preheating NH₃ by absorption of heat from heated cooling water.

45. The plant as claimed in claim 44, wherein the heated cooling water exits from a process cooler upstream of the device for purification of H₂, including a pressure swing adsorption device, in flow direction of the product gas.

46. The plant as claimed in claim 44, wherein the heated cooling water exits from a heat exchanger of an H₂ compressor.

47. The plant as claimed in claim 44, wherein the heated cooling water exits from a steam condensate heat exchanger downstream of the NH₃ evaporation device in flow direction of the steam condensate, and downstream of any preheater.

48. The plant as claimed in claim 37, further comprising:
upstream of the NH₃ evaporation device, upstream of any preheater, and downstream of any preheating device, in flow direction of the NH₃, an additional heat exchanger for preheating NH₃ by absorption of heat from water; and
downstream of the flue gas heat exchanger in flow direction of the flue gas, a further heat exchanger for heating of the water by absorption of heat from the flue gas.

49. The plant as claimed in claim 48, wherein the additional heat exchanger and the further heat exchanger are connected to one another via a ring conduit for circulating the water.

50. The plant as claimed in claim 37, wherein the plant comprises at least five heat exchangers, including the preheating device, the additional heat exchanger, the preheater, the product gas heat exchanger and the flue gas heat exchanger.

51. A process for producing H₂ by catalytic decomposition of NH₃, comprising:
(a) combusting a combustion gas to produce heat of combustion and flue gas;
(e) evaporating liquid NH₃ by absorption of heat from heated water;
(f) catalytically decomposing NH₃ evaporated in step (e), with absorption of heat of combustion generated in step (a) and production of a product gas comprising H₂ and N₂; and
(g) heating water by absorption of heat from the flue gas produced in step (a) and/or from the product gas produced in step (f), and introducing the heated water into step (e).

52. The process as claimed in claim 51, further comprising:
(d) heating NH₃ by absorption of heat from water obtained by step (e).

53. The process as claimed in claim 51, further comprising:
(b) preheating NH₃ by absorption of heat from heated cooling water.

54. The process as claimed in claim 53, wherein the heated cooling water has previously absorbed heat from the product gas before implementation of the purification of H₂ by pressure swing adsorption, and/or from H₂ after it has been compressed.

55. The process as claimed in claim 51, further comprising:
(c) preheating NH₃ by absorption of heat from water; and heating the water thus obtained by absorption of heat from the flue gas.

56. The process as claimed in claim 51, wherein a residual gas mixture that remains after removal of the H₂ in the apparatus for purification of H₂, including a pressure swing adsorption device, is returned via a return conduit and fed to the combustion device via a branching conduit.
